(19) United States
(12) Patent Application Publication
(10) Pub. No.: US 2026/0331133 A1
(43) Pub. Date: Oct. 22, 2026

(54) SERVO MEASUREMENT APPARATUS, SERVO MEASUREMENT METHOD, PROGRAM, METHOD OF PRODUCING A MAGNETIC TAPE, AND MAGNETIC TAPE

(71) Applicant: Sony Group Corporation, Tokyo (JP)

(72) Inventors: Hiroshi MORITA, Tokyo (JP); Futoshi SASAKI, Tokyo (JP)

(21) Appl. No.: 19/564,878

(22) Filed: Mar. 12, 2026

(30) Foreign Application Priority Data
Apr. 21, 2025 (JP) 2025-069509

(51) Int. Cl. G11B 5/592

(52) U.S. Cl. CPC G11B 5/5928

(57) ABSTRACT

Provided is a servo measurement apparatus including: a servo read head that reads a servo pattern written to a servo band of a magnetic tape and reproduces a servo signal with a waveform; and a control unit that calculates a width of the servo pattern on the basis of a first point and a second point that are respectively different from a peak point on a positive side and a peak point on a negative side in the waveform of the servo signal.

### CROSS REFERENCE TO RELATED APPLICATIONS

This application claims the benefit of Japanese Priority Patent Application JP 2025-069509 filed Apr. 21, 2025, the entire contents of which are incorporated herein by reference.

### BACKGROUND

The present technology relates to a technology such as a servo measurement apparatus that executes measurement related to a servo pattern on a magnetic tape.

### SUMMARY

A magnetic tape is provided with a plurality of data bands on which data is recorded and a plurality of servo bands on which servo patterns are recorded. In the magnetic tape, first, a servo pattern is recorded on a servo band by a servo write head of a servo recording apparatus.

Meanwhile, a data write head of a data recording apparatus writes data to an arbitrary position of the data band while recognizing the position of the magnetic tape on the basis of the servo pattern written on a magnetic tape (see WO 2023/153024).

It is desirable to provide a technology such as a servo measurement apparatus that enables a user to easily and accurately measure a width of a servo pattern.

In view of the above circumstances, the present technology has been made to provide a technology such as the servo measurement apparatus that enables the user to easily and accurately measure the width of the servo pattern.

A servo measurement apparatus according to an embodiment of the present technology includes a servo read head and a control unit.

The servo read head reads a servo pattern written to a servo band of a magnetic tape and reproduces a servo signal with a waveform.

The control unit calculates a width of the servo pattern on the basis of a first point and a second point that are respectively different from a peak point on a positive side and a peak point on a negative side in the waveform of the servo signal.

This provides the servo measurement apparatus that enables the user to easily and accurately measure the width of the servo pattern.

In the servo measurement apparatus, the control unit may set a point corresponding to any one of rise portions of crests on the positive side in the waveform of the servo signal as the first point.

In the servo measurement apparatus, the control unit may set a point corresponding to any one of rise portions of troughs on the negative side in the waveform of the servo signal as the second point.

In the servo measurement apparatus, the control unit may set, when an output value of the peak point on the positive side in the waveform of the servo signal is set to 100%, a point corresponding to an output value, which is a first percentage with respect to the peak point on the positive side, as the first point.

In the servo measurement apparatus, the control unit may set, when the output value of the peak point on the negative side in the waveform of the servo signal is set to −100%, a point corresponding to an output value, which is a second percentage with respect to the peak point on the negative side, as the second point.

In the servo measurement apparatus, the control unit may set any value within a range of 25% or more and 75% or less as the first percentage.

In the servo measurement apparatus, the control unit may set any value within a range of −25% or more and −75% or less as the second percentage.

In the servo measurement apparatus, the control unit may set the first percentage and the second percentage such that absolute values of the first percentage and the second percentage are equal.

In the servo measurement apparatus, the magnetic tape may include a magnetic layer of a perpendicularly oriented type to which the servo pattern is written.

In the servo measurement apparatus, the magnetic layer may have a squareness ratio in a perpendicular direction of 60% or more.

In the servo measurement apparatus, the control unit may be capable of changing at least one of the first point or the second point.

In the servo measurement apparatus, the control unit may change at least one of the first point or the second point on the basis of a perpendicular orientation of a magnetic layer to which the servo pattern is written.

In the servo measurement apparatus, the control unit may be capable of changing at least one of the first percentage or the second percentage.

In the servo measurement apparatus, the control unit may change at least one of the first percentage or the second percentage on the basis of a perpendicular orientation of a magnetic layer to which the servo pattern is written.

In the servo measurement apparatus, the control unit may measure the width of the servo pattern for each servo truck in the servo band.

In the servo measurement apparatus, an old data recording apparatus compatible with a magnetic tape of an old LTO type may be reused as the servo measurement apparatus.

A servo measurement method according to an embodiment of the present technology includes:
reading a servo pattern written to a servo band of a magnetic tape and reproducing a servo signal with a waveform; and
calculating a width of the servo pattern on the basis of a first point and a second point that are respectively different from a peak point on a positive side and a peak point on a negative side in the waveform of the servo signal.

A program according to an embodiment of the present technology causes a servo measurement apparatus to execute processing including:
reading a servo pattern written to a servo band of a magnetic tape and reproducing a servo signal with a waveform; and
calculating a width of the servo pattern on the basis of a first point and a second point that are respectively different from a peak point on a positive side and a peak point on a negative side in the waveform of the servo signal.

A method of producing a magnetic tape according to an embodiment of the present technology includes:
reading a servo pattern written to a servo band of a magnetic tape and reproducing a servo signal with a waveform;
calculating a width of the servo pattern on the basis of a first point and a second point that are respectively different from a peak point on a positive side and a peak point on a negative side in the waveform of the servo signal; and
checking quality of the magnetic tape on the basis of the width of the servo pattern.

In a magnetic tape according to an embodiment of the present technology,
a servo pattern written to a servo band of a magnetic tape is read and a servo signal with a waveform is reproduced,
a width of the servo pattern is calculated on the basis of a first point and a second point that are respectively different from a peak point on a positive side and a peak point on a negative side in the waveform of the servo signal, and
quality of the magnetic tape is checked on the basis of the width of the servo pattern.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram of a magnetic tape as viewed from the side;

FIG. 2 is a schematic diagram of the magnetic tape as viewed from above (magnetic layer side);

FIG. 3 is a diagram showing a servo pattern written to the magnetic tape;

FIG. 4 is a diagram showing a servo recording/reproduction apparatus according to this embodiment;

FIG. 5 is an enlarged diagram of a servo write head and a servo element of the servo write head;

FIG. 6 is a diagram showing how a servo pattern is written to the magnetic tape by the servo write head;

FIG. 7 is an enlarged view of the right view of FIG. 5 and is a diagram showing an example of specific dimensions in a first servo element (“/”) and a second servo element (“¥”);

FIG. 8 is a diagram representing the servo write head with reference to a coordinate system of the servo write head;

FIG. 9 is an enlarged view of the right view of FIG. 8 and is a diagram showing an example of specific dimensions in the first servo element (“/”) and the second servo element (“¥”) (with reference to the X″Y″Z″ coordinate system);

FIG. 10 is a diagram showing a servo measurement apparatus according to this embodiment;

FIG. 11 is a diagram showing how the servo read head is reading servo patterns in servo bands;

FIG. 12 is a side view showing how the servo write head of the servo recording/reproduction apparatus is writing the servo pattern to the magnetic layer of the magnetic tape and is a diagram showing a width of the servo pattern;

FIG. 13 is a diagram for describing a basic concept of a measurement method for the width of the servo pattern according to this embodiment;

FIG. 14 is another diagram for describing the basic concept of the measurement method for the width of the servo pattern according to this embodiment;

FIG. 15 is a diagram showing an MFM image of the servo pattern on a magnetic tape of a type A and a magnetic force waveform by an MEM;

FIG. 16 is a diagram showing a waveform of the servo signal when the servo pattern in the magnetic tape of the type A was read;

FIG. 17 is a diagram showing the width of the servo pattern for each servo band and for each servo truck (for each servo trace line) in the magnetic tape of the type A;

FIG. 18 is a diagram showing the MFM image of the servo pattern in a magnetic tape of a type B and the magnetic force waveform by the MEM;

FIG. 19 is a diagram showing the waveform of the servo signal when the servo pattern in the magnetic tape of the type B was read;

FIG. 20 is a diagram showing the width of the servo pattern for each servo band and for each servo truck (for each servo trace line) in the magnetic tape of the type B;

FIG. 21 is a diagram for describing a matching degree between the width of the servo pattern measured by the measurement method according to this embodiment and the width of the servo pattern 7 measured by the measurement method in the MFM;

FIG. 22 is a flowchart showing processing of a control unit; and

FIG. 23 is a flowchart showing the processing of the control unit.

### DETAILED DESCRIPTION OF EMBODIMENTS

Hereinafter, an embodiment according to the present technology will be described with reference to the drawings.

### First Embodiment

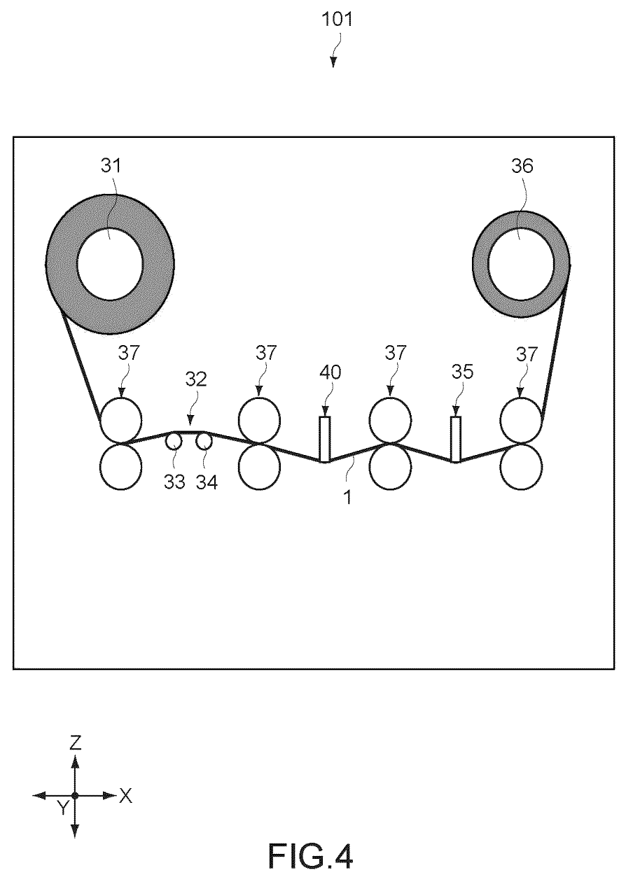

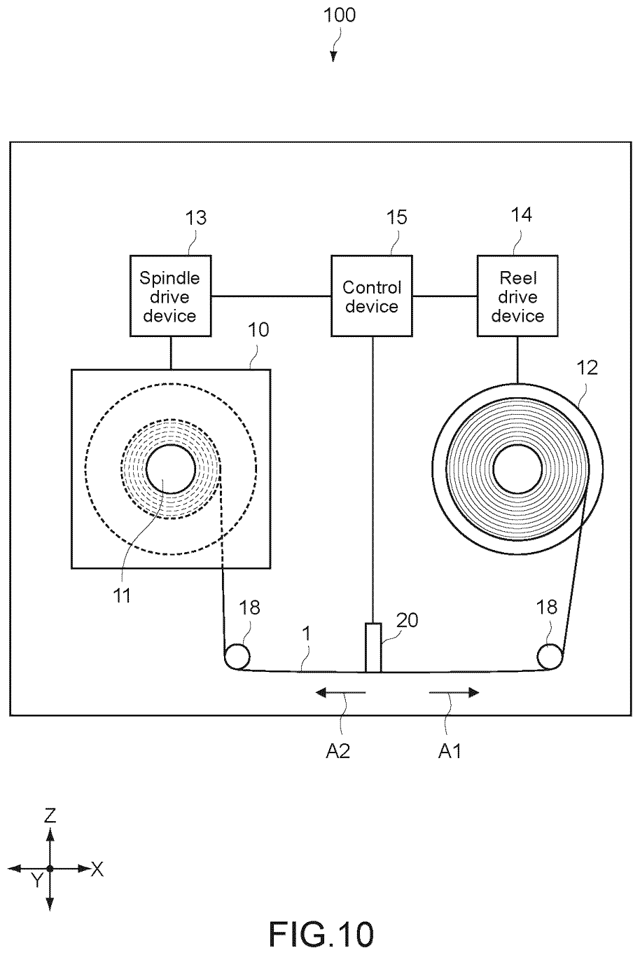

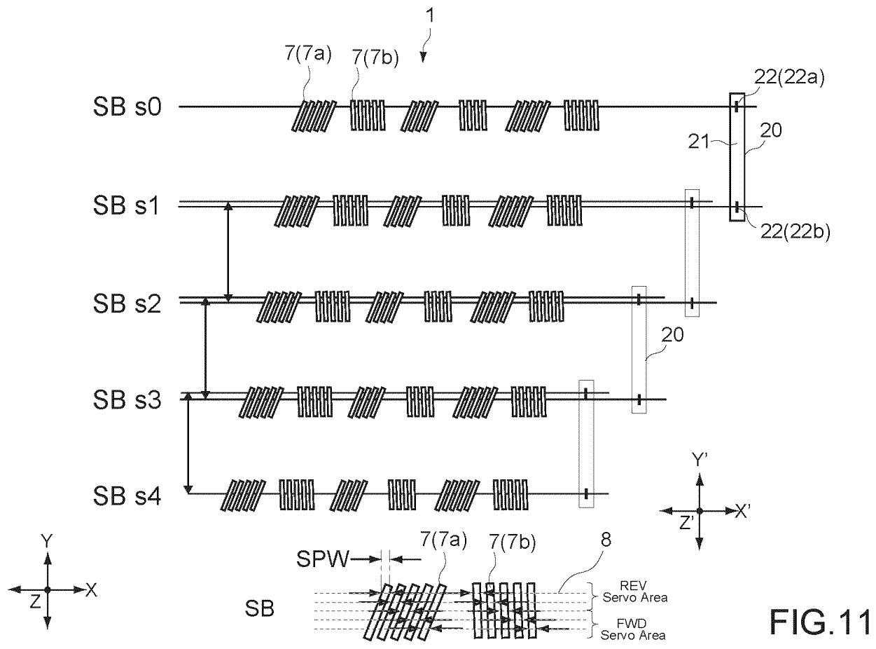

In this embodiment, a width SPW (see FIG. 11 and the like) of a servo pattern 7 written on a magnetic tape 1 by a servo recording/reproduction apparatus 101 (see FIG. 4 and the like) is measured by a servo measurement apparatus 100 (see FIG. 10 and the like).

In the description of this embodiment, the magnetic tape 1, the servo recording/reproduction apparatus 101, and the servo measurement apparatus 100 will be described in the stated order.

### Configuration of Magnetic Tape 1

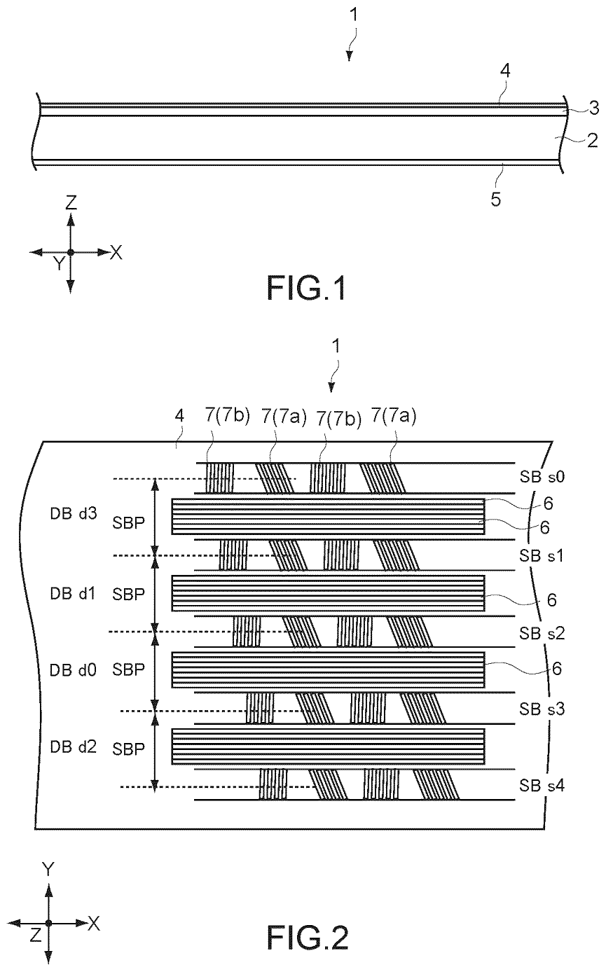

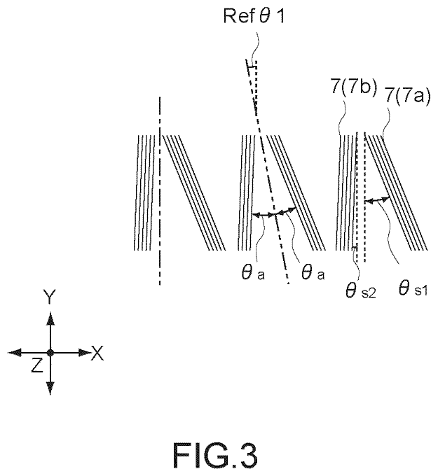

FIG. 1 is a schematic diagram of the magnetic tape 1 as viewed from the side, and FIG. 2 is a schematic diagram of the magnetic tape 1 as viewed from above (side of a magnetic layer 4). FIG. 3 is a diagram showing the servo pattern 7 written to the magnetic tape 1.

As shown in FIG. 1 and FIG. 2, the magnetic tape 1 is configured to have a tape shape that is long in the longitudinal direction (X-axis direction), short in a width direction (Y-axis direction), and thin in a thickness direction (Z-axis direction).

The width (Y-axis direction) of the magnetic tape 1 is typically approximately ½ inch, the width of the magnetic tape 1 may be approximately 1 inch, and the size thereof can be changed as appropriate.

The magnetic tape 1 includes a base material 2 having a tape shape that is long in the longitudinal direction (X-axis direction), an underlayer 3 (non-magnetic layer) that is provided on one main surface of the base material 2, the magnetic layer 4 provided on the underlayer 3, and a back layer 5 that is provided on the other main surface of the base material 2.

Note that the back layer 5 only needs to be provided as necessary and this back layer 5 may be omitted. The magnetic layer 4 may be a coated film of a magnetic material or may be a deposition film or a sputtering film of a magnetic material.

In this embodiment, the magnetic layer 4 is made of a perpendicularly oriented type. Further, in this embodiment, a squareness ratio S1 of the magnetic layer 4 in a perpendicular direction of the magnetic tape 1 (Z-axis direction: thickness direction) is 60% or more, 65% or more, 70% or more, 75% or more, 80% or more, or the like.

In this embodiment, a perpendicular orientation of the magnetic layer 4 is set to a relatively high value because the squareness ratio S1 of the magnetic layer 4 in the perpendicular direction of the magnetic tape 1 is 60% or more. The technology according to this embodiment is effective especially as a method of measuring the width SPW of the servo pattern 7 in the magnetic tape 1 including such a magnetic layer 4 whose perpendicular orientation is set to a relatively high value.

Note that details of the respective layers constituting the magnetic tape 1 will be described below.

As shown in FIG. 2, the magnetic layer 4 includes a plurality of data bands d (data bands d0 to d3) to which data is written, and a plurality of servo bands s (servo bands s0 to s4) to which the servo pattern 7 is written. The plurality of data bands d and the plurality of servo bands s each have a shape that is long in the longitudinal direction (X-axis direction) and short in the width direction (Y-axis direction). The servo bands s are disposed at positions sandwiching the respective data bands d in the width direction (Y-axis direction).

Four servo bands s are arranged at predetermined intervals in the width direction (Y-axis direction). In the description of the present specification, a distance in the width direction between two servo bands s adjacent to each other in the width direction (Y-axis direction) is called servo band pitch SBP. Typically, the servo band pitch SBP is a distance between a center position in the width direction of the magnetic tape 1 in the servo pattern 7 of one servo band s of the two servo bands s adjacent to each other and a center position in the width direction of the magnetic tape 1 in the servo pattern 7 of the other servo band s.

In the example shown in FIG. 2, the number of data bands d is four and the number of servo bands s is five. Note that the number of data bands d and the number of servo bands s can be changed as appropriate.

The ratio of the area of the servo band s to the area of the entire surface of the magnetic layer 4 is, for example, 4.0% or less. Note that the width of the servo band s is, for example, 96 μm or less in the case of a tape width of ½ inch. The ratio of the area of the servo band s to the area of the entire surface of the magnetic layer 4 can be measured by, for example, developing the magnetic tape 1 using a developer such as a ferricolloid developer and then observing the developed magnetic tape 1 with an optical microscope.

A data band d includes a plurality of recording tracks 6 that is long in the longitudinal direction and aligned in the width direction. The number of recording tracks 6 included in one data band d is, for example, approximately 1000 to 2500. Data is recorded in the recording tracks 6 along the recording tracks 6. The 1-bit length in the longitudinal direction of data recorded in the data band d is, for example, 48 nm or less.

Further, the width (track pitch: Y-axis direction) of the recording track 6 is, for example, 2.0 μm or less. Note that such a recording track width can be measured by, for example, developing the magnetic layer 4 of the magnetic tape 1 using a developer such as a ferricolloid developer and then observing the developed magnetic layer 4 of the magnetic tape 1 with an optical microscope.

Alternatively, as a method of measuring the recording track width, a method of using a data write head in a head inclined-type data recording/reproduction apparatus (not shown) may be used. In this case, the data write head is made in a recording and reproduction state in order to ignore fluctuations during traveling of the magnetic tape 1, and the recording track width can be measured on the basis of the change in output when an azimuth angle of the data write head is changed. (IEEE_Sept1996_Crosstrack Profiles of Thin Film MR Tape Heads Using the Azimuth Displacement Method)

The servo band s includes a plurality of servo bursts each including a plurality of servo patterns 7 to be recorded by the servo recording/reproduction apparatus 101 (see FIG. 4) described below. The servo pattern 7 includes a first servo pattern 7a (“¥”) and a second servo pattern 7b (“/”).

Note that in the present specification, the symbols “/” and “¥” in the first servo pattern 7a and the second servo pattern 7b are used as symbols indicating the inclination direction of the servo pattern 7 when it is viewed from a direction corresponding to the figure described at that time. For example, since FIG. 2 is a diagram of the magnetic tape 1 as viewed from the top surface side (on the side of the magnetic layer 4: above), the symbols “/” and “¥” in the first servo pattern 7a and the second servo pattern 7b are used as symbols as the magnetic tape 1 is viewed from the top surface side.

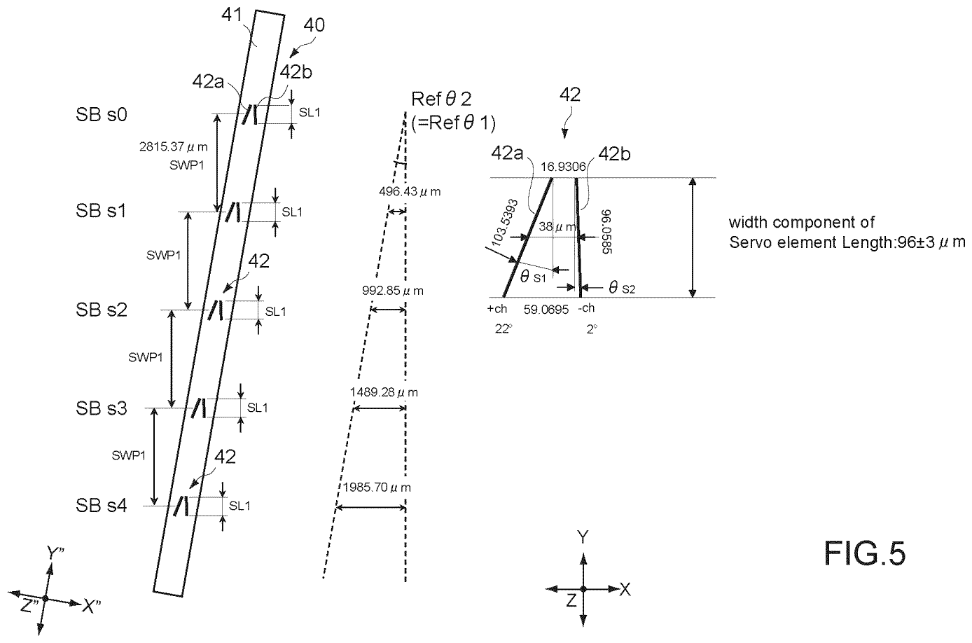

Meanwhile, each of the figures (FIG. 5 to FIG. 9 and FIG. 11) to be described later may show a state of the magnetic tape 1 as viewed from the back surface side (on the side of the back layer 5: below). In these cases, the symbols “/” and “¥” are used as symbols as the magnetic tape 1 is correspondingly viewed from the back surface side. That is, the symbols “/” and “¥” are inverted between a case where the magnetic tape 1 is viewed from the top surface side and a case where the magnetic tape 1 is viewed from the back surface side. The same applies to a first servo element 42a and a second servo element 42b that write the servo patterns 7 to the magnetic tape 1 (see FIG. 5 and the like).

Referring to the left side of FIG. 3, when a direction parallel to the width direction (Y-axis direction) of the magnetic tape 1 is set as a direction of a symmetry axis (see the long dashed short dashed line on the left side of FIG. 3), the first servo pattern 7a (“¥”) and the second servo pattern 7b (“/”) are written to the servo band s so as to be asymmetric with respect to this symmetry axis.

Note that in the case of a general servo pattern 7, when the direction parallel to the width direction of the magnetic tape 1 is set as the direction of the symmetry axis, the first servo pattern 7a (“¥”) and the second servo pattern 7b (“/”) are written to the servo band s so as to be symmetrical (line symmetrical).

Further, referring to the center of FIG. 3, the symmetry axis (see the long dashed double-short dashed line at the center of FIG. 3) of the first servo pattern 7a (“¥”) and the second servo pattern 7b (“/”) is set to be non-parallel with respect to the width direction of the magnetic tape 1 (Y-axis direction).

Typically, the first servo pattern 7a (“¥”) and the second servo pattern 7b (“/”) are formed to be symmetric with respect to the symmetry axis. Note that the length (length in the direction along θs1) of the first servo pattern 7a (“¥”) and the length (length in the direction along θs2) of the second servo pattern 7b (“/”) are different (length in the width direction of the magnetic tape 1 is the same: the length of the first servo pattern 7a×Cos θs1=the length of the second servo pattern 7b×Cos θs2).

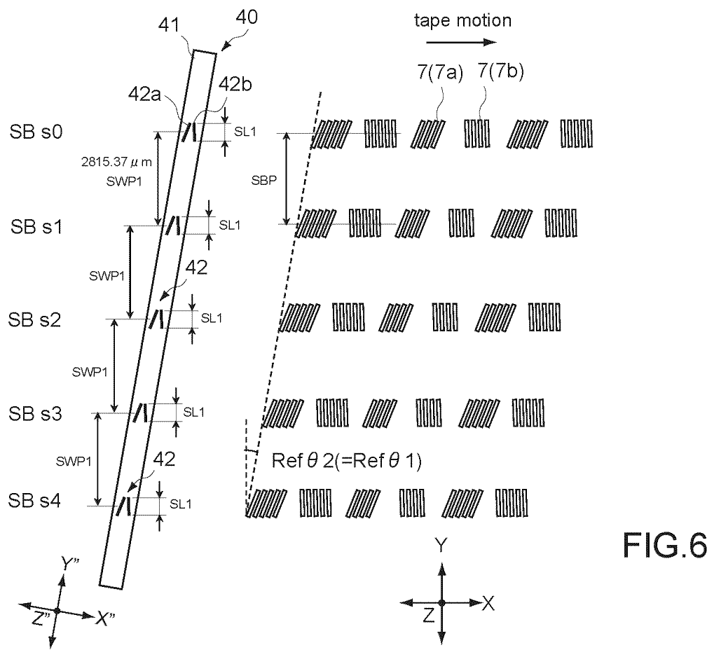

A first inclination angle Refθ1, which is an angle at which the symmetry axis is inclined with respect to the width direction of the magnetic tape 1, is set to, for example, 10° in this embodiment. Note that the first inclination angle Refθ1 is typically set to 8° or more. The first inclination angle Refθ1 is equal to a second inclination angle Refθ2 at which the servo write head 40 of the servo recording/reproduction apparatus 101 is inclined with respect to the width direction of the magnetic tape 1 (see FIG. 5, FIG. 6, and the like to be described later).

Further, the first inclination angle Refθ1 is typically equal to the angle at which the data write head that records data on the data band d of the magnetic tape 1 is inclined with respect to the width direction of the magnetic tape 1 in the head inclined-type data recording/reproduction apparatus (not shown). Note that the angle at which the data write head is inclined with respect to the width direction of the magnetic tape 1 varies within, for example, a range of Refθ1±x (the value of x is typically 0.7° or less).

The first servo pattern 7a (“¥”) is inclined at a servo azimuth angle θa with respect to the symmetry axis counter-clockwise. Further, the second servo pattern 7b (“/”) is inclined at the servo azimuth angle θa with respect to the symmetry axis clockwise. Note that the first servo pattern 7a (“¥”) and the second servo pattern 7b (“/”) are inclined with respect to the symmetry axis at the same angle θa (servo azimuth angle).

Referring to the right side in FIG. 3, the first servo pattern 7a (“¥”) is inclined at a first angle θs1 with respect to the width direction of the magnetic tape 1 (Y-axis direction) and the second servo pattern 7b (“/”) is inclined at a second angle θs2 different from the first angle θs1 in a direction opposite to the first angle θs1 with respect to the width direction of the magnetic tape 1.

The first angle θs1 at which the first servo pattern 7a (“¥”) is inclined with respect to the width direction of the magnetic tape 1 is a value obtained by adding θa to the first inclination angle Refθ1 and is represented by an equation below. Further, the angle θs2 at which the second servo pattern 7b (“/”) is inclined with respect to the width direction of the magnetic tape 1 is a value obtained by subtracting Oa from the first inclination angle Refθ1 and is represented by an equation below (counter-clockwise is positive as viewed from the upper side).

θs1=Refθ1+θa

θs2=Refθ1−θa

Assuming that the first inclination angle Refθ1 is 10° and the servo azimuth angle θa is 12°, the first angle θs1 is 22° and the second angle θs2 is −2°. Note that the values of Refθ1, θa, θs1, and θs2 are not limited to the examples taken here, and can be changed as appropriate.

The first servo burst (“¥”) and the second servo burst (“/”) are alternately arranged in the longitudinal direction of the magnetic tape 1. The number of first servo patterns 7a (“¥”) included in the first servo burst (“¥”) is typically set to 4 or 5. Similarly, the number of second servo patterns 7b (“/”) included in the second servo burst (“/”) is typically 4 or 5.

Note that in the description of this embodiment, a case where the first servo pattern 7 (“¥”) and the second servo pattern 7 (“/”) are set to be asymmetric with respect to the width direction of the magnetic tape 1 as the direction of the symmetry axis will be described. However, the first servo pattern 7 and the second servo pattern 7 may be set to be symmetric with respect to the width direction of the magnetic tape 1 as the direction of the symmetry axis (the direction of the symmetry axis may be parallel with respect to the width direction of the magnetic tape 1).

Here, regarding the magnetic tape 1 according to Linear Tape Open (LTO) standards, the number of record trucks 6 has increased and the record capacity has dramatically improved with each generation. Taking an example, although LTO-1 in the first generation includes 384 record trucks 6, LTO-2 to LTO-9 include 512 record trucks 6, 704 record trucks 6, 896 record trucks 6, 1280 record trucks 6, 2176 record trucks 6, 3584 record trucks 6, 6656 record trucks 6, and 8960 record trucks 6 in the stated order. Also in terms of the record capacity of the data, although LTO-1 has 100 GB (gigabyte), LTO-2 to LTO-9 have 200 GB, 400 GB, 800 GB, 1.5 TB (terabyte), 2.5 TB, 6.0 TB, 12 TB, and 18 TB in the stated order. Further, LTO-10, LTO-11, and LTO-12 planned in future are assumed to have 36 TB, 72 TB, and 144 TB as the record capacity of the data.

In this embodiment, the number of record trucks 6 and the record capacity are not particularly limited, and they can be changed as appropriate. Note that for example, it is advantageous to apply the present technology to the magnetic tape 1 larger in the number of record trucks 6 and the record capacity (e.g., 6656 or more, 12 TB or more: LTO8 or later).

### Servo Recording/Reproduction Apparatus 101

Next, the servo recording/reproduction apparatus 101 according to an embodiment of the present technology will be described. FIG. 4 is a diagram showing the servo recording/reproduction apparatus 101 according to this embodiment.

As shown in FIG. 4, the servo recording/reproduction apparatus 101 includes a feed roller 31, a demagnetizing unit 32, a servo write head 40, a servo read head 35, a winding roller 36, and four pairs of capstan rollers 37.

The feed roller 31 is capable of rotatably supporting the rolled magnetic tape 1. The feed roller 31 rotates in accordance with driving of a motor or the like, and feeds out the magnetic tape 1 toward the downstream side in accordance with the rotation.

The winding roller 36 is capable of rotatably supporting the rolled magnetic tape 1. The winding roller 36 rotates in accordance with driving of a motor or the like, and winds up the magnetic tape 1 in accordance with the rotation.

The four pairs of capstan rollers 37 are capable of sandwiching the magnetic tape 1 from both sides in the up-and-down direction. The four pairs of capstan rollers 37 rotate in accordance with rotation of a motor or the like, and convey the magnetic tape 1 along the conveying path in accordance with the rotation.

The feed roller 31, the winding roller 36, and the four pairs of capstan rollers 37 are capable of conveying the magnetic tape 1 at a constant speed within the conveying path.

The servo write head 40 is disposed above, for example, the magnetic tape 1 (on the side of the magnetic layer 4). The servo write head 40 applies a magnetic field to the servo band s at a predetermined timing in accordance with a pulse signal of a square wave to record the servo pattern 7 on the servo band s.

The servo write head 40 is capable of recoding the servo pattern 7 on all the servo bands s (s0 to s4) when the magnetic tape 1 passes below the servo write head 40. Note that details of the configuration of the servo write head 40 will be described below with reference to FIG. 5 to FIG. 9.

The demagnetizing unit 32 is disposed below, for example, the magnetic tape 1 (on the side of the base material 2) on the upstream side of the servo write head 40. The demagnetizing unit 32 includes, for example, two permanent magnets 33 and 34. The permanent magnets 33 and 34 apply, before the servo write head 40 records the servo pattern 7, a magnetic field to the entire magnetic layer 4 using a DC magnetic field to demagnetize the entire magnetic layer 4. Further, the permanent magnets 33 and 34 are configured to be capable of applying on the magnetic layer 4 a magnetic field in a direction opposite to that of a magnetic field applied on the servo bands s by the servo write head 40. This configuration can provide a reproduction waveform of the servo signal with a favorable symmetric property.

The servo read head 35 is disposed above the magnetic tape 1 (on the side of the magnetic layer 4) on the downstream side of the servo write head 40. The servo read head 35 is configured to be capable of reproducing information of the servo pattern 7 by reading the magnetic field generated from the servo pattern 7 recorded on the magnetic tape 1.

The servo read head 35 is capable of reading the servo pattern 7 from all the servo bands s (s0 to s4) when the magnetic tape 1 passes below the servo read head 35. The information of the servo pattern 7 read by the servo read head 35 is used to check whether or not the servo pattern 7 has been accurately recorded.

Examples of the type of servo read head 35 include an inductive type, an MR type (Magneto Resistive), a GMR type (Giant Magneto Resistive), and a TMR type (Tunnel Magneto Resistive).

### Servo Write Head 40

Next, the configuration of the servo write head 40 will be described in detail. Here, the data write head in the head inclined-type data recording/reproduction apparatus (not shown) is disposed, inclined with respect to the width direction of the magnetic tape 1 in order to cope with variations in the width of the magnetic tape 1.

Therefore, the direction of the symmetry axis (see the center in FIG. 3) of the first servo pattern 7a (“¥”) and the second servo pattern 7b (“/”) is set to be inclined with respect to the width direction of the magnetic tape 1 such that the servo patterns 7 can be accurately read by the data write head. This writing of the servo patterns 7 is executed by the servo write head 40 according to this embodiment.

FIG. 5 is an enlarged diagram of the servo write head 40 and a servo element 42 of the servo write head 40. FIG. 6 is a diagram showing how the servo pattern 7 is written to the magnetic tape 1 by the servo write head 40.

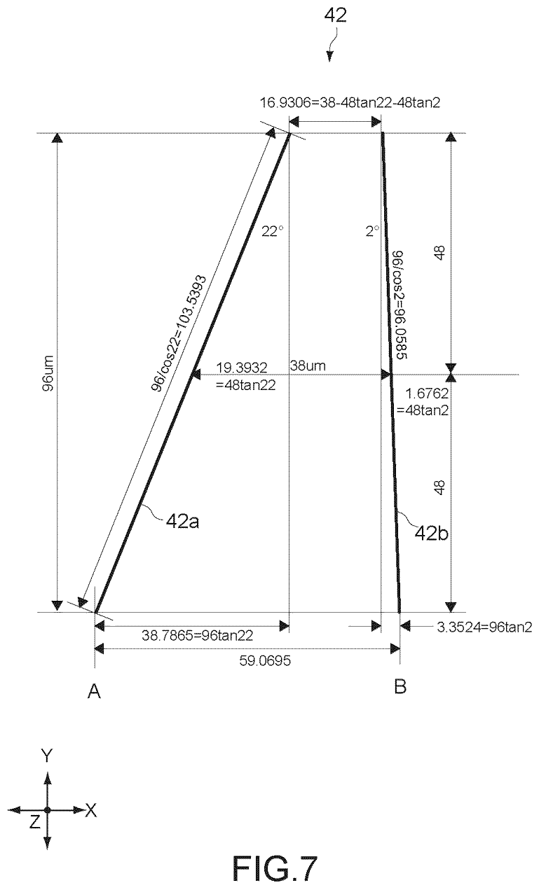

FIG. 5 and FIG. 6 show a state of the servo write head 40 as viewed from the lower side (as viewed from the top surface side opposite to the magnetic tape 1). In FIG. 5 and FIG. 6, since the servo write head 40 and the like are viewed from the lower side, the symbols “/” and “¥” in the first servo pattern 7a and the second servo pattern 7b and the symbols “/” and “¥” in the first servo element 42a and the second servo element 42b are opposite to those in FIG. 2, FIG. 3, and the like. The same applies to FIG. 7 to FIG. 9 and FIG. 11 to be described later.

As shown in these figures, the servo write head 40 has a shape long in the longitudinal direction (Y″-axis direction) and short in the width direction (X″-axis direction).

The servo write head 40 is disposed so that the longitudinal direction (Y″-axis direction) of the servo write head 40 is tilted at a predetermined angle (second inclination angle Refθ2) with respect to the width direction of the magnetic tape 1 (Y-axis direction). The second inclination angle Refθ2 at which the longitudinal direction (Y″-axis direction) of the servo write head 40 is inclined with respect to the width direction of the magnetic tape 1 (Y-axis direction) is equal to the first inclination angle Refθ1 at which the symmetry axis of the first servo pattern 7a and the second servo pattern 7b is inclined with respect to the width direction of the magnetic tape 1 in the magnetic tape 1 (e.g., 10°) (Refθ2=Refθ1).

The servo write head 40 includes a facing surface 41 opposite to the magnetic tape 1. The facing surface 41 has a shape long in the longitudinal direction (Y″-axis direction) and short in the width direction (X″-axis direction).

The servo write head 40 includes five pairs of servo elements 42 (magnetic gaps) on the facing surface 41. Each servo element 42 is a magnetic gap provided in the servo write head 40. The servo element 42 is capable of writing the servo patterns 7 to the servo bands s with leakage flux from the magnetic gaps.

The five pairs of servo elements 42 are arranged at predetermined intervals (servo write pitches: SWP1) in the width direction of the magnetic tape 1 (Y-axis direction).

The distance (servo write pitch: SWP1) in the width direction of the magnetic tape 1 (Y-axis direction) between the two pairs of servo elements 42 adjacent to each other is set to, for example, 2815.3±4.6 μm. Note that this value corresponds to the distance (servo band pitch SBP) in the width direction of the magnetic tape 1 between two servo bands s adjacent to each other in the width direction of the magnetic tape 1 (Y-axis direction) in the magnetic tape 1. That is, the servo write pitch SWP1 is typically equal to the servo band pitch SBP.

Further, a position difference between the two pairs of servo elements 42 adjacent to each other in the longitudinal direction of the magnetic tape 1 (X-axis direction) is represented by SWP1×Tan (Refθ2).

Assumption is made that the value of SWP1 is 2815.37 μm and the second inclination angle Refθ2 is 10°. In this case, the position difference between the two pairs of servo elements 42 adjacent to each other in the longitudinal direction of the magnetic tape 1 (X-axis direction) is 2815.37 μm×Tan 10°=496.43 μm.

When the width direction of the magnetic tape 1 (Y-axis direction) is set as the direction of the symmetry axis, the pair of servo elements 42 includes the first servo element 42a (“/”) and the second servo element 42b (“¥”) configured to be asymmetric with respect to the symmetry axis (see especially the right side of FIG. 5).

Further, the symmetry axis of the first servo element 42a (“/”) and the second servo element 42b (“¥”) are set to be non-parallel with respect to the width direction of the magnetic tape 1 (Y-axis direction). Typically, the first servo element 42a (“/”) and the second servo element 42b (“¥”) are formed to be symmetric with respect to the symmetry axis.

The angle at which the symmetry axis of the first servo element 42a (“/”) and the second servo element 42b (“¥”) is inclined with respect to the width direction of the magnetic tape 1 is equal to the first inclination angle Refθ1 at which the symmetry axis of the first servo pattern 7a (“/”) and the second servo pattern 7b (“¥”) is inclined with respect to the width direction of the magnetic tape 1 (the angle is also equal to the second inclination angle Refθ2).

The first servo element 42a (“/”) is inclined at the first angle θs1 with respect to the width direction of the magnetic tape 1 (Y-axis direction). The second servo element 42b (“¥”) is inclined opposite to the first angle θs1 at the second angle θs2 with respect to the width direction of the magnetic tape 1 (Y-axis direction).

The first angle θs1 at which the first servo element 42a (“/”) is inclined with respect to the width direction of the magnetic tape 1 is the value obtained by adding the servo azimuth angle θa to the second inclination angle Refθ2 and is represented by an equation below. Further, the angle θs2 at which the second servo pattern 7b (“¥”) is inclined with respect to the width direction of the magnetic tape 1 is a value obtained by subtracting the servo azimuth angle θa from the second inclination angle Refθ2 and is represented by an equation below (clockwise is positive as viewed from the lower side).

θs1=Refθ2+θa

θs2=Refθ2−0a

Assuming that the second inclination angle Refθ2 is 10° and the servo azimuth angle θa is 12°, the first angle θs1 is 22° and the second angle θs2 is −2°.

Here, in the first servo element 42a (“/”), the direction along the first angle θs1 (direction at 22° with respect to the width direction of the magnetic tape 1) is the longitudinal direction of the first servo element 42a (“/”). Further, in the second servo element 42b (“¥”), the direction along the second angle θs2 (direction at −2° with respect to the width direction of the magnetic tape 1) is the longitudinal direction of the second servo element 42b (“¥”).

The length in the longitudinal direction of the first servo element 42a (“/”) is different from the length in the longitudinal direction of the second servo element 42b (“¥”). In this example, the length in longitudinal direction of the first servo element 42a (“/”) is longer than the length in the longitudinal direction of the second servo element 42b (“¥”).

Meanwhile, a width direction (Y-axis direction) component SL1 of the magnetic tape 1 in the length in the longitudinal direction of the first servo element 42a (“/”) and a width direction (Y-axis direction) component SL1 of the magnetic tape 1 in the length in the longitudinal direction of the second servo element 42b (“¥”) are the same. The width direction component SL1 of the length of the servo element 42 is, for example, 96±3 μm.

FIG. 7 is an enlarged view of the right view of FIG. 5 and is a diagram showing an example of specific dimensions in the first servo element 42a (“/”) and the second servo element 42b (“¥”) (with reference to the XYZ coordinate system).

As shown in FIG. 7, the length in the longitudinal direction of the first servo element 42a (“/”) is 103.5393 μm (=96 μm/Cos 22°). Further, the length in the longitudinal direction of the second servo element 42b (“¥”) is 96.0585 μm (=96 μm/Cos 2°).

Further, the interval (X-axis direction) between the upper end portion of the first servo element 42a (“/”) and the upper end portion of the second servo element 42b (“¥”) is 16.9306 μm (=38 μm−48 μm×Tan 22°−48 μm×Tan 2°=38 μm−19.3932 μm−1.6762 μm).

Further, the interval (X-axis direction) between the lower end portion of the first servo element 42a (“/”) and the lower end portion of the second servo element 42b (“¥”) is 59.0695 μm (=96 μm×Tan 22°+16.9306 μm+96 μm×Tan 2°=38.7865 μm+16.9306 μm+3.3524 μm).

Further, the interval between the first servo element 42a (“/”) and the second servo element 42b (“¥”) in the longitudinal direction of the magnetic tape 1 (X-axis direction) is set to, for example, 38 μm at a ½ position of the width direction component SL of the length of the servo element 42.

Here, the first servo pattern 7a (“/”) to be written on the magnetic tape 1 by the first servo element 42a (“/”) has a configuration basically similar to that of the first servo element 42a (“/”) described here. Further, the second servo pattern 7b (“/”) to be written on the magnetic tape 1 by the second servo element 42b (“¥”) has a configuration basically similar to that of the second servo element 42b (“¥”) described here.

For example, further, the length in the longitudinal direction of the first servo pattern 7a (“/”) is set to about 103.5393 μm (=96) μm/Cos 22° (the value may vary depending on the magnetic field to a small extent). Further, the length in the longitudinal direction of the second servo pattern 7b (“¥”) is set to about 96.0585 μm (=96) μm/Cos 2° (the value may vary depending on the magnetic field to a small extent).

FIG. 6 shows the servo patterns 7 written to the five servo bands s by the five pairs of servo elements 42. Note that pulse signals corresponding to the same phase are respectively input to the five pairs of servo elements 42 at the same time and the servo patterns 7 are respectively written to the five servo bands s.

The phase difference in the width direction of the magnetic tape 1 of the servo patterns 7 to be written to two servo bands s adjacent to each other in the width direction of the magnetic tape 1 (Y-axis direction) is represented by SWP1×Tan (Refθ2).

Assumption is made that the value of SWP1 is 2815.37 μm and the inclination angle Refθ is 10°. In this case, the phase difference of the servo patterns 7 to be written to two servo bands s adjacent to each other is 2815.37 μm×Tan 10°=496.43 μm.

Note that the phase differences of the servo patterns 7 of the servo band s1, the servo band s2, the servo band s3, and the servo band s4 with reference to the servo pattern 7 of the servo band so are phases corresponding to 496.43 μm, 992.85 μm, 1489.28 μm, and 1985.70 μm, respectively.

Of the servo patterns 7 written to the five servo bands s, the servo pattern 7 of the servo band so has the most advanced phase in the width direction of the magnetic tape 1 (Y-axis direction). The order of the phases is then the servo pattern 7 of the servo band s1, the servo pattern 7 of the servo band s2, the servo pattern 7 of the servo band s3, and the servo pattern 7 of the servo band s4.

For example, in the case where description is made with the servo pattern 7 of the servo band s0 and the servo pattern 7 of the servo band s1, the phase of the servo pattern 7 of the servo band so in the width direction of the magnetic tape 1 is earlier than the servo pattern 7 of the servo band s1 by the phase corresponding to 496.43 μm.

In the magnetic tape 1, the phases of the servo patterns 7 written to the five servo bands s are the same in the direction at the second inclination angle Refθ2 (10°) of the data write head 20 with respect to the width direction of the magnetic tape 1 (Y-axis direction).

In the above description, the configuration of the servo write head 40 with reference to the coordinate system (XYZ coordinate system) of the magnetic tape 1 has been described. The configuration of the servo write head 40 with reference to the coordinate system (X″Y″Z″ coordinate system) of the servo write head 40 will be described below.

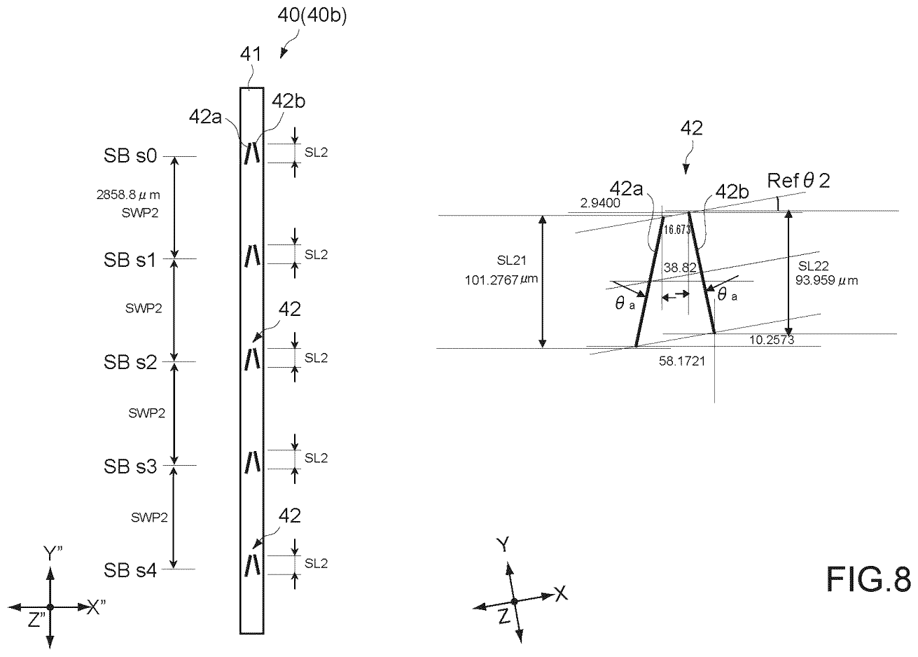

FIG. 8 is a diagram showing the servo write head 40 with reference to the coordinate system of the servo write head 40 and is a diagram of the servo write head 40 as viewed from the lower side (facing top surface side).

As shown in FIG. 8, the five pairs of servo elements 42 are arranged at predetermined intervals (servo write pitches: SWP2) in the longitudinal direction of the servo write head 40 (Y″-axis direction). In the longitudinal direction of the servo write head 40 (Y″-axis direction), the interval between two pairs of servo elements 42 adjacent to each other (servo write pitch: SP2) is represented by SWP1×Cos⁻¹ (Refθ2).

For example, assumption is made that in the width direction of the magnetic tape 1 (Y-axis direction), the interval between two pairs of servo elements 42 adjacent to each other (servo write pitch: SWP1) is 2815.37 μm and the second inclination angle Refθ2 of the servo write head 40 is 10°. In this case, in the longitudinal direction of the servo write head 40 (Y″-axis direction), the interval between two pairs of servo elements 42 adjacent to each other (servo write pitch: SWP2) is 2858.8 μm.

Here, the symmetry axis of the first servo element 42a (“/”) and the second servo element 42b (“¥”) is non-parallel to the width direction of the magnetic tape 1 (Y-axis direction) (direction at the inclination angle refθ2 with respect to the width direction), but is parallel to the longitudinal direction of the servo write head 40 (Y″-axis direction).

The first servo element 42a (“/”) is inclined at the servo azimuth angle θa with respect to the longitudinal direction of the servo write head 40 (Y″-axis direction). Meanwhile, the second servo element 42b (“¥”) is inclined opposite to the first servo element 42a (“/”) at the same servo azimuth angle θa as that of the first servo element 42a (“/”) with respect to the longitudinal direction of the servo write head 40 (Y″-axis direction).

Here, in the first servo element 42a (“/”), the direction along the servo azimuth angle θa (direction of 10° with respect to the longitudinal direction of the servo write head 40) is the longitudinal direction of the first servo element 42a (“/”). Further, in the second servo element 42b (“¥”), the direction along the servo azimuth angle θa (direction of −10° with respect to the longitudinal direction of the servo write head 40) is the longitudinal direction of the second servo element 42b (“¥”).

The length in the longitudinal direction of the first servo element 42a (“/”) is different from the length in the longitudinal direction of the second servo element 42b (“¥”). In this example, the length in longitudinal direction of the first servo element 42a (“/”) is longer than the length in the longitudinal direction of the second servo element 42b (“¥”).

Further, a longitudinal direction (Y″-axis direction) component SL21 of the servo write head 40 in the length in the longitudinal direction of the first servo element 42a (“/”) and a longitudinal direction (Y″-axis direction) component SL22 of the servo write head 40 in the length in the longitudinal direction of the second servo element 42b (“¥”) are also different from each other.

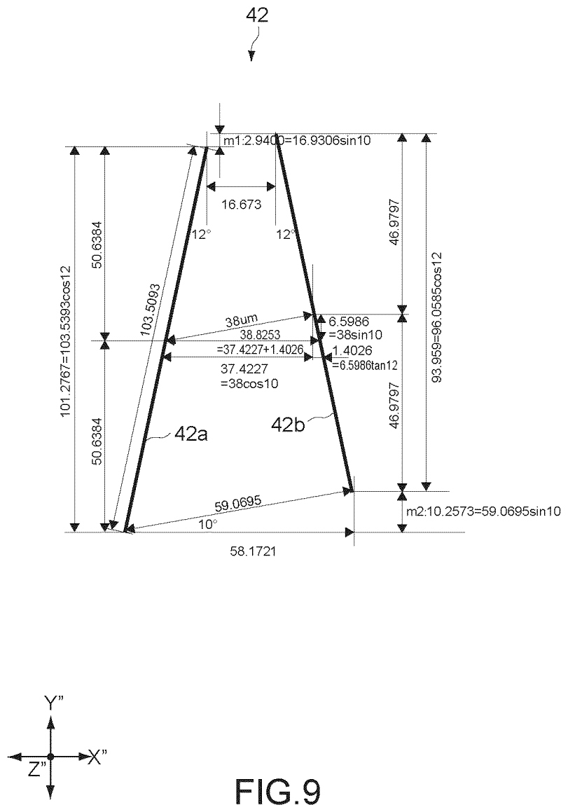

FIG. 9 is an enlarged view of the right view of FIG. 8 and is a diagram showing an example of specific dimensions in the first servo element 42a (“/”) and the second servo element 42b (“¥”) (with reference to the X″Y″Z″ coordinate system).

Assumption is made that the width direction (Y-axis direction) component SL1 of the magnetic tape 1 in the length of the servo element 42 is 96 μm, the second inclination angle Refθ2 of the servo write head 40 is 10°, and the servo azimuth angle θa is 12°.

In this case, the longitudinal direction (Y″-axis direction) component SL21 of the servo write head 40 in the length of the first servo element 42a (“/”) is 101.2767 μm (=103.5093 μm×Cos 12°). Further, in this case, the longitudinal direction (Y″-axis direction) component SL22 of the servo write head 40 in the length of the second servo element 42b (“¥”) is 93.959 μm (=96.0585 μm×Cos 12°) μm.

Further, in the width direction of the servo write head 40 (X″-axis direction), the interval between the upper end portion of the first servo element 42a (“/”) and the upper end portion of the second servo element 42b (“¥”) is 16.673 μm (=16.9306 μm×Cos 10°. Further, in the longitudinal direction of the servo write head 40 (Y″-axis direction), the difference between the position of the upper end portion of the first servo element 42a (“/”) and the position of the upper end portion of the second servo element 42b (“¥”) is 2.94 μm (=16.9306 μm×Sin 10°).

Further, in the width direction of the servo write head 40 (X″-axis direction), the interval between the lower end portion of the first servo element 42a (“/”) and the lower end portion of the second servo element 42b (“¥”) is 58.1721 μm (=59.0695 μm×Cos 10°). Further, in the longitudinal direction of the servo write head 40 (Y″-axis direction), the difference between the position of the lower end portion of the first servo element 42a (“/”) and the position of lower end portion of the second servo element 42b (“¥”) is 10.2573 μm (=59.0695 μm×Sin 10°).

Further, in the width direction of the servo write head 40 (X″-axis direction), the interval between (centers) of the first servo element 42a (“/”) and the second servo element 42b (“¥”) is, for example, 38.8253 μm (38 μm×Cos 10°+ (38 μm×Sin 10°)×Tan 12°=37.4227 μm+6.5986 μm×Tan 12°=37.4227 μm+1.4026 μm).

### Servo Measurement Apparatus 100

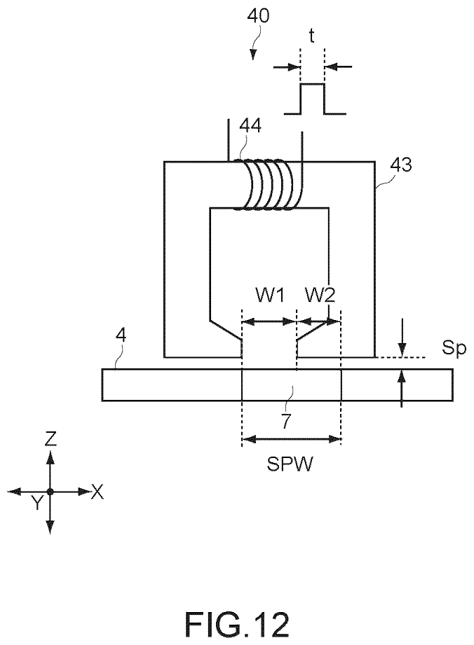

Next, the servo measurement apparatus 100 according to this embodiment will be described. FIG. 10 is a diagram showing the servo measurement apparatus 100 according to this embodiment. The servo measurement apparatus 100 according to this embodiment is configured to be capable of measuring the width SPW of the servo pattern 7 (see FIG. 11, FIG. 12, and the like) recorded on the magnetic tape 1.

In this embodiment, an old data recording/reproduction apparatus that is compatible with a magnetic tape 1 of an old LTO type (e.g., LTO-7, LTO-8, LTO-9, or the like) is reused as the servo measurement apparatus 100 basically as it is (note that it is necessary to newly add a program in the control unit). Here, the word “old” means that it is old when this technology is used and also includes those that will become old in future.

By reusing the old data recording/reproduction apparatus as the servo measurement apparatus 100 in this manner, the costs can be reduced and the global environment can also be considered. Note that it is not necessarily necessary to reuse the old data recording/reproduction apparatus as the servo measurement apparatus 100, and a dedicated servo measurement apparatus 100 can also be newly manufactured.

Referring to FIG. 10, the servo measurement apparatus 100 is configured to be capable of loading a cartridge 10. The cartridge 10 is configured to be capable of rotatably accommodating the wound magnetic tape 1 therein. The servo measurement apparatus 100 may be configured to be capable of loading a single cartridge 10 or may be configured to be capable of loading a plurality of cartridges 10 at the same time.

The servo measurement apparatus 100 includes a spindle 11, a take-up reel 12, a spindle drive device 13, a reel drive device 14, the servo read head 20, a control device 15, and a plurality of guide rollers 18.

The spindle 11 is configured to be capable of causing the magnetic tape 1 housed in the cartridge 10 to rotate by the rotation thereof. The spindle drive device 13 causes the spindle 11 to rotate in accordance with a command from the control device 15.

The take-up reel 12 is configured to be capable of fixing the tip of the magnetic tape 1 pulled out from the cartridge 10 via a tape loading mechanism (not shown). The reel drive device 14 causes the take-up reel 12 to rotate in accordance with a command from the control device 15.

The plurality of guide rollers 18 guides the traveling of the magnetic tape 1 such that the conveying path formed between the cartridge 10 and the take-up reel 12 has a predetermined relative positional relationship with respect to the servo read head 20.

The servo read head 20 is configured to be capable of reading the servo pattern 7 recorded on the magnetic tape 1 when the magnetic tape 1 passes below the servo read head 20, and reproducing the servo signal. The data write head previously provided in the old data recording/reproduction apparatus to be reused is used as this servo read head 20.

The data write head is configured to be capable of recording data on the data band d (recording track 6) of the magnetic tape 1 and reproducing the recorded data. However, this function of the data write head is not used in this embodiment.

When the servo pattern 7 of the magnetic tape 1 is read by the servo read head 20, the spindle 11 and the take-up reel 12 are caused to rotate by the spindle drive device 13 and the reel drive device 14 and the magnetic tape 1 travels. Regarding the traveling direction of the magnetic tape 1, the magnetic tape 1 can be reciprocated in the forward direction indicated by an arrow A1 in FIG. 6 (direction of unwinding from the side of the spindle 11 to the side of the take-up reel 12) and the reverse direction indicated by an arrow A2 (direction of rewinding from the side of the take-up reel 12 to the side of the spindle 11).

The servo read head 20 is capable of reading the servo pattern 7 and reproducing the servo signal in both directions of traveling of the magnetic tape 1 in the forward direction and traveling of the magnetic tape 1 in the reverse direction.

Here, the old data recording/reproduction apparatus to be reused may include two data write heads of a data write head for the forward direction and a data write head for the reverse direction.

In such a case, only one data write head of the two data write heads may be used as the servo read head 20 or both the two data write heads may be used as the servo read heads 20. In a case where both the two data write heads are used as the servo read heads 20, the servo read head 20 to be used may be changed in accordance with a change of the traveling direction of the magnetic tape 1 into the forward direction or the reverse direction.

The control device 15 includes, for example, a control unit, a storage unit, a communication unit, and the like. The control unit includes a CPU (Central Processing Unit) or the like, and integrally controls the respective units of the servo measurement apparatus 100 in accordance with a program stored in the storage unit.

The storage unit includes a non-volatile memory on which various types of data and various programs are to be recorded, and a volatile memory to be used as a work area of the control unit. The various programs described above may be read from a portable recording medium such as an optical disc and a semiconductor memory, or may be downloaded from a server apparatus in a network. The communication unit is configured to be capable of communicating with other devices such as a PC (Personal Computer) and a server apparatus.

FIG. 11 is a diagram showing how the servo read head 20 is reading the servo patterns 7 in the servo bands s and is a diagram of the servo read head 20 as viewed from the lower side (facing top surface side).

As shown in FIG. 11, the servo read head 20 is disposed so that the longitudinal direction (Y′-axis direction) of the servo read head 20 is parallel to the width direction of the magnetic tape 1 (Y-axis direction). Further, the servo read head 20 is movable in the width direction of the magnetic tape 1 (Y-axis direction) (longitudinal direction (Y′-axis direction of the servo read head unit 20)).

Note that the servo read head 20 may be disposed, inclined with respect to the width direction of the magnetic tape 1 at a predetermined angle (equal to the first inclination angle Refθ1, the second inclination angle Refθ2: 10°) (e.g., in a case where the head inclined-type data recording/reproduction apparatus is used as the servo measurement apparatus 100).

The servo read head 20 has a facing surface 21 that faces the magnetic tape 1. The facing surface 21 has a shape that is long in the longitudinal direction (Y′-axis direction) of the servo read head 20 and short in the width direction (X′-axis direction) of the servo read head 20. Two servo read units 22 and a plurality of data write/read units 23 are provided on the facing surface 21.

The servo read units 22 include a first servo read unit 22a provided on one side of the data write head 20 in the longitudinal direction (Y′-axis direction) and a second servo read unit 22b provided on the other side. The first servo read unit 22a and the second servo read unit 22b are arranged with a predetermined interval (servo read pitch: SRP) in the longitudinal direction (Y′-axis direction) of the servo read head 20 (width direction of the magnetic tape 1 (Y-axis direction)).

The interval (servo read pitch SRP) is a distance between the center position in the longitudinal direction of the servo read head 20 in the first servo read unit 22a and the center position in the longitudinal direction of the servo read head 20 in the first servo read unit 22a. The servo read pitch SRP is set to, for example, 2858.8 μm±1 μm.

The servo read unit 22 is configured to be capable of reproducing a servo signal by reading, by an MR element (MR: Magneto Resistive effect) or the like, the magnetic field generated by the servo pattern 7 recorded on the servo band s of the magnetic tape 1.

As the MR element, for example, an anisotropic magnetoresistive element (AMR: Anisotropic Magneto Resistive effect), a giant magnetoresistive element (GMR: Giant Magneto Resistive effect), a tunnel magnetoresistive element (TMR: Tunnel Magneto Resistive effect), or the like is used.

Note that the data write head of the old data recording/reproduction apparatus to be reused includes, on the facing surface 21, a data write unit that records data on the data band d of the magnetic tape 1 and a data read unit that reads data recorded on the data band d, though the illustration is omitted because these are not used in this embodiment.

The first servo read unit 22a is capable of reading the servo pattern 7 in one servo band s of the two servo bands s adjacent to each other in the width direction of the magnetic tape 1 (Y-axis direction). Further, the second servo read unit 22b is capable of reading the servo pattern 7 in the other servo band s of the two servo bands s adjacent to each other in the width direction of the magnetic tape 1 (Y-axis direction).

Specifically, when the first servo read unit 22a is located on the servo band s0, s1, s2, or s3 and reads the servo pattern 7, the second servo read unit 22b is located on the servo band s1, s2, s3 or s4 directly below that servo band and reads the servo pattern 7.

Note that a width (Y-axis direction) of a servo truck 8 in reading of the servo pattern 7 in the first servo read unit 22a and the second servo read unit 22b is set to approximately 1 μm or more and 5 μm or less (in a case where the servo read head 20 is inclined, the width of the servo truck 8 is approximately 0.1 μm or more and 1.5 μm or less).

The control unit measures the width SPW of the servo pattern 7 in one servo band s of the two servo bands s adjacent to each other in the width direction of the magnetic tape 1 on the basis of the servo signal from the first servo read unit 22a. Further, the control unit measures the width SPW of the servo pattern 7 in the other servo band s on the basis of the servo signal from the second servo read unit 22b.

As shown on the lower side of FIG. 11, the width of the servo band s is capable of performing measurement for each servo truck 8 (for each servo trace line). The servo trucks 8 (servo trace lines) are trucks in a direction along the longitudinal direction of the magnetic tape 1 (X-axis direction) and are set at predetermined intervals in the width direction of the magnetic tape 1 (Y-axis direction). On the basis of servo signals from the servo read units 22, the control unit adjusts the position in the width direction of the magnetic tape 1 (Y-axis direction) in the servo read head 20 so that the servo read units 22 can accurately trace the position of any servo truck 8.

Note that in the servo pattern 7, the region upper than the center in the width direction of the magnetic tape 1 is a region to be read when the magnetic tape 1 is traveling in the reverse direction in the servo measurement apparatus 100. Meanwhile, in the servo pattern 7, the region lower than the center in the width direction of the magnetic tape 1 is a region to be read when the magnetic tape 1 is traveling in the forward direction in the servo measurement apparatus 100.

### Width SPW of Servo Pattern 7

Next, the width SPW of the servo pattern 7 will be described. FIG. 12 is a side view showing how the servo write head 40 of the servo recording/reproduction apparatus 101 is writing the servo pattern 7 to the magnetic layer 4 of the magnetic tape 1 and is a diagram showing the width SPW of the servo pattern 7.

The servo write head 40 of the servo recording/reproduction apparatus 101 includes a head block 43 having a generally inverted U-shape as viewed from the side (Y-axis direction). The head block 43 includes a magnetic gap on its lower side. The magnetic gap corresponds to the above-mentioned servo element 42. A width W1 of the magnetic gap is, for example, about 1 μm.

A coil 44 is spirally wound around the head block 43. A rectangular pulse signal is input to the coil 44. When the rectangular pulse signal is High, a magnetic flux is generated in the head block 43 and a leakage flux is generated from the magnetic gap (servo element 42). Due to this leakage flux, the servo pattern 7 is written to the magnetic layer 4 of the magnetic tape 1.

The width SPW of the servo pattern 7 corresponds to a distance in the longitudinal direction of the magnetic tape 1 (X-axis direction) of a portion magnetized as the servo pattern 7 in the magnetic layer 4. Note that in the present specification, the expression, “width direction of the servo pattern 7,” may be used, and this width direction of the servo pattern 7 corresponds to the longitudinal direction of the magnetic tape 1 (X-axis direction).

The width SPW of the servo pattern 7 is substantially equal to a value obtained by subtracting a spacing factor Spf based on a spacing Sp from an additive value of the width W1 of the magnetic gap (the longitudinal direction of the magnetic tape 1 (X-axis direction)) and a record current distance W2. That is, SPW=W1+W2−Spf.

The record current distance W2 is a distance (X-axis direction) of a portion magnetized due to traveling of the magnetic tape 1. Assuming that a High time of the pulse signal is t and the tape traveling speed is v, the record current distance W2 is represented by t×v.

The spacing Sp is a distance in the thickness direction of the magnetic tape 1 (Z-axis direction) between the lower surface of the head block 43 (record surface of the servo write head 40) and the upper surface of the magnetic layer 4. The spacing factor Spf is a function of the spacing Sp and is a value that increases with an increase in the spacing Sp. That is, when the spacing Sp increases (the distance between the lower surface of the head block 43 and the upper surface of the magnetic layer 4 increases), the spacing factor Spf increases, so the width SPW of the servo pattern 7 decreases.

### Basic Concept of Present Technology

Next, a basic concept of a measurement method for the width SPW of the servo pattern 7 will be described.

In the LTO standards, criteria to be satisfied by the magnetic tape 1 are specified in detail, and these are also specified for the width SPW of the servo pattern 7. Therefore, certain criteria have to be satisfied also for the width SPW of the servo pattern 7. Thus, it is desirable to regularly measure the width SPW of the servo pattern 7 in the magnetic tape 1.

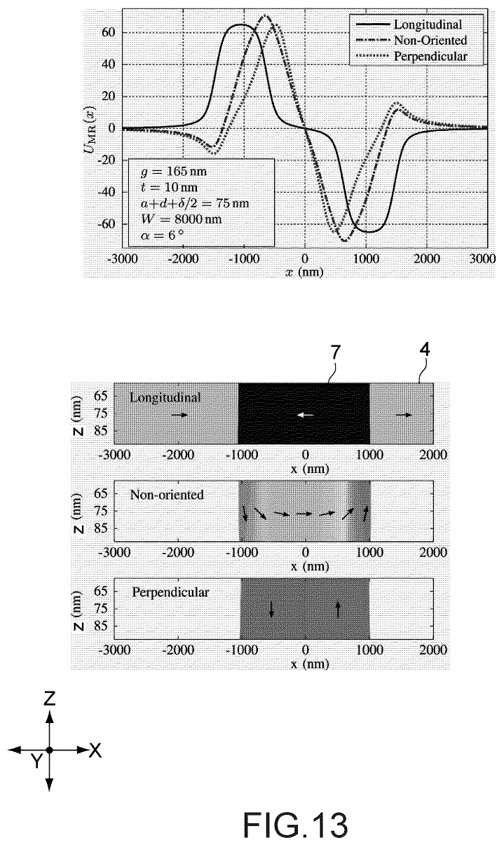

FIG. 13 is a diagram for describing the basic concept of the measurement method for the width SPW of the servo pattern 7 according to this embodiment.

On the upper side in FIG. 13, the servo signal (see the solid line) when the servo pattern 7 recorded on the magnetic layer 4 of a longitudinally oriented type is read, the servo signal (see the long dashed short dashed line) when the servo pattern 7 recorded on the magnetic layer 4 of a non-oriented type is read, and the servo signal (see the broken line) when the servo pattern 7 recorded on the magnetic layer 4 of a perpendicularly oriented type is read are shown.

Further, on the lower side of FIG. 13, the servo pattern 7 recorded on the magnetic layer 4 of the longitudinally oriented type, the servo pattern 7 recorded on the magnetic layer 4 of the non-oriented type, and the servo pattern 7 recorded on the magnetic layer 4 of the perpendicularly oriented type are shown in order from above.

In a case of the longitudinally oriented type, the direction of magnetization of the servo pattern 7 is a direction along the longitudinal direction of the magnetic tape 1 (X-axis direction). Further, its orientation is an orientation opposite to a portion not magnetized.

Further, in a case of the non-oriented type, the direction of magnetization of the servo pattern 7 is a direction along a leak magnetic field (direction along the ellipse) of the magnetic gap (servo element 42). Further, its orientation is gradually reversed up and down in the longitudinal direction of the magnetic tape 1.

Further, in a case of the perpendicularly oriented type, the direction of magnetization of the servo pattern 7 is a direction along the thickness direction of the magnetic tape 1 (Z-axis direction). Further, its orientation is reversed up and down at the approximately ½ position in the longitudinal direction of the magnetic tape 1.

In a case of the longitudinally oriented type, positions of a peak point on a positive side and a peak point on a negative side in the output waveform of the servo signal are substantially equal to positions of both end portions of the servo pattern 7 in the width direction of the servo pattern 7. Thus, the value (the detection time difference×the traveling speed of the magnetic tape 1) obtained by converting a detection time difference between the detection time at the peak point on the positive side and the detection time at the peak point on the negative side into a distance is substantially equal to the width SPW of the servo pattern 7. Hereinafter, this the measurement method for the width SPW of the servo pattern 7 will be referred to as a peak-to-peak measurement method.

Meanwhile, in cases of the non-oriented type and the perpendicularly oriented type, the positions of the peak point on the positive side and the peak point on the negative side in the output waveform of the servo signal do not match the positions of the both end portions of the servo pattern 7 in the width direction of the servo pattern 7 at all. Specifically, the positions of the peak point on the positive side and the peak point on the negative side in the output waveform of the servo signal are shifted inward from the positions of the both end portions of the servo pattern 7 in the width direction of the servo pattern 7. The higher the perpendicular orientation of the magnetic layer 4 (squareness ratio S1 in the perpendicular direction), the larger this amount of shift.

Therefore, in cases of the non-oriented type and the perpendicularly oriented type, the value (the detection time difference×the traveling speed of the magnetic tape 1) obtained by converting the detection time difference between the detection time at the peak point on the positive side and the detection time at the peak point on the negative side into a distance is not equal to the width SPW of the servo pattern 7 and is smaller than the width SPW of the servo pattern 7. Thus, in the peak-to-peak measurement method, it is difficult to measure the width SPW of the actual servo pattern 7.

In the LTO standards, there has been a demand for high-density recording along with the generation progresses, and the perpendicular orientation of the magnetic layer 4 has increased in response to this demand. Thus, an alternative measurement method to the above-mentioned peak-to-peak measurement method has been necessary. This alternative method is, for example, a measurement method by a magnetic force microscope (MFM).

The magnetic force microscope is configured to be capable of converting a distribution of magnetic force gradients of an observation target into an image. Meanwhile, the measurement of the width SPW of the servo pattern 7 by the magnetic force microscope has a problem in that a high level skill is necessary. Further, even with a high level skill, it also has a problem in that it takes a long time to complete the measurement.

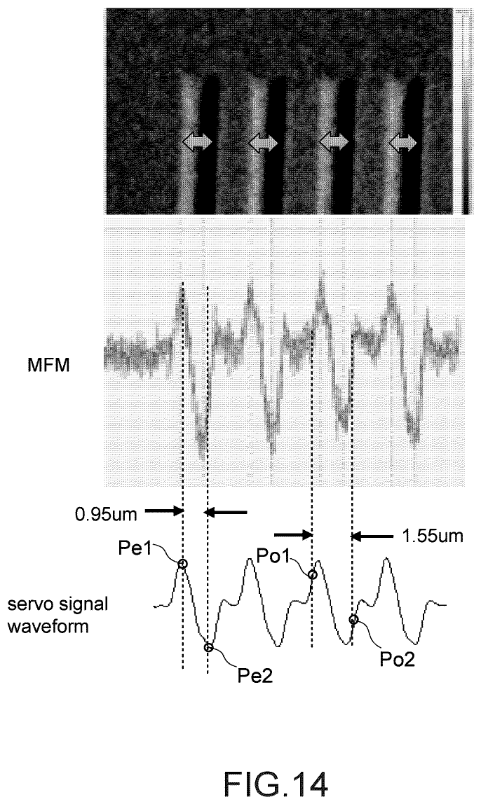

FIG. 14 is another diagram for describing the basic concept of the measurement method for the width SPW of the servo pattern 7 according to this embodiment.

On the upper side of FIG. 14, an image from the MFM is shown. At the center of FIG. 14, a magnetic force waveform detected by the MFM is shown. On the lower side of FIG. 14, the waveform of the servo signal is shown.

In the measurement of the width SPW of the servo pattern 7 by the MFM, not only an image shown on the upper side of FIG. 14, but also the magnetic force waveform shown at the center of FIG. 14 are consulted. In the magnetic force waveform, a distance (1.55 μm) between a start point and an end point in the magnetic force waveform, not the peak-to-peak distance in the waveform, is measured as the width SPW of the servo pattern 7.

Referring to the lower side of FIG. 14, a value (about 0.95 μm) obtained by converting the detection time difference between the peak-to-peak in the waveform of the servo signal into a distance is completely different from the width SPW of the actual servo pattern 7. Meanwhile, a value (1.55 μm) obtained by converting the detection time difference between predetermined two points in the waveform of the servo signal into a distance is substantially equal to the width SPW of the actual servo pattern 7.

In view of this, in this embodiment, a method in which the width SPW of the servo pattern 7 in the servo measurement apparatus 100 is measured on the basis of a first point Po1 and a second point Po2 respectively different from a peak point Pe1 on the positive side in the waveform of the servo signal and a peak point Pe2 on the negative side is employed.

It is believed that this method can overcome the problems in that the high level skill like the measurement by the MFM is necessary and that it takes a long time to complete the measurement. That is, the user can easily measure the width SPW of the servo pattern 7 with the servo measurement apparatus 100. The above is the basic concept of the present technology.

### Measurement Method for Width SPW of Servo Pattern 7

Next, the measurement method for the width SPW of the servo pattern 7 will be described in detail. In the example here, two types of magnetic tapes 1, the magnetic tape 1 of the type A and the magnetic tape 1 of the type B, were prepared, and the width SPW of the servo pattern 7 in the magnetic tape 1 was actually measured.

The magnetic tape 1 of the type A and the magnetic tape 1 of the type B are different in the width SPW of the servo pattern 7 because the servo patterns 7 are written by different types of servo write heads 40.

Here, in FIG. 12, as described above, the width SPW of the servo pattern 7 is substantially equal to a value obtained by subtracting the spacing factor Spf based on the spacing Sp from an additive value of the width W1 of the magnetic gap (the longitudinal direction of the magnetic tape 1 (X-axis direction)) and the record current distance W2. That is, SPW=W1+W2−Spf.

The record current distance W2 and the spacing factor Spf are set to basically constant values. However, the width W1 of the magnetic gap is not constant due to differences in the type of the servo write head 40, individual differences, and the like. Thus, the width SPW of the servo pattern 7 may differ due to differences in the type of the servo write head 40, individual differences, or the like.

### Magnetic Tape 1 of Type A

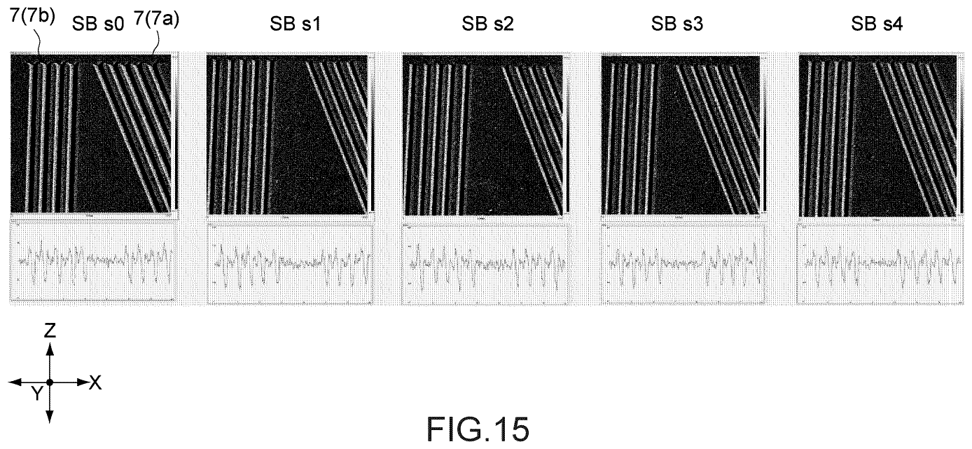

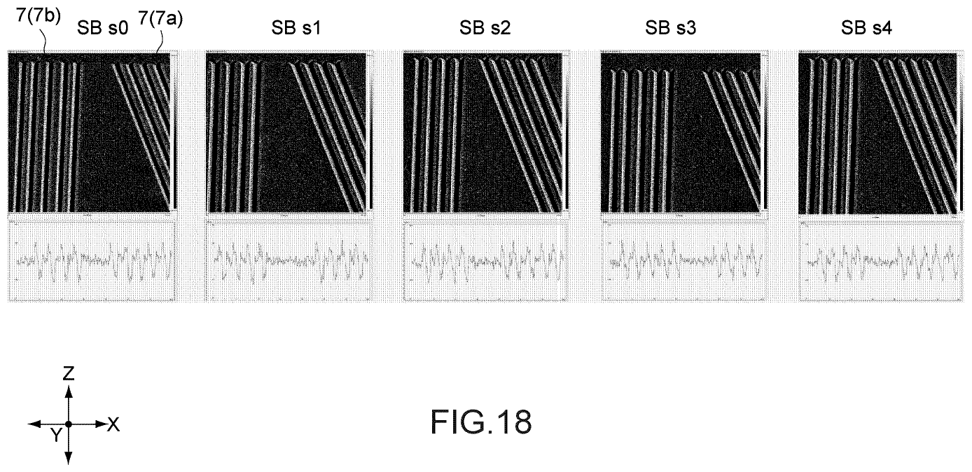

FIG. 15 is a diagram showing an MFM image of the servo pattern 7 in the magnetic tape 1 of the type A and the magnetic force waveform by the MEM. Note that the MEM image in FIG. 15 shows a state of the magnetic tape 1 of the type A as viewed from the upper side (on the side of the magnetic layer 4) (the same applies to FIG. 17, FIG. 18, and FIG. 20 to be described later).

Each MFM image shown in FIG. 15 shows the servo patterns 7 (servo bursts) on the servo bands s different in the magnetic tape 1 of the type A. Each MFM image is an image of 35 μm×35 μm (vertical×horizontal). In the example shown in FIG. 15, in the MFM measurement based on the MFM image and the magnetic force waveform, the width SPW (average value) of the servo pattern 7 of the servo band s0 and the servo band s4 was 1.6 μm and the width SPW (average value) of the servo pattern 7 of the servo band s1, the servo band s2, and the servo band s3 was 1.5 μm.

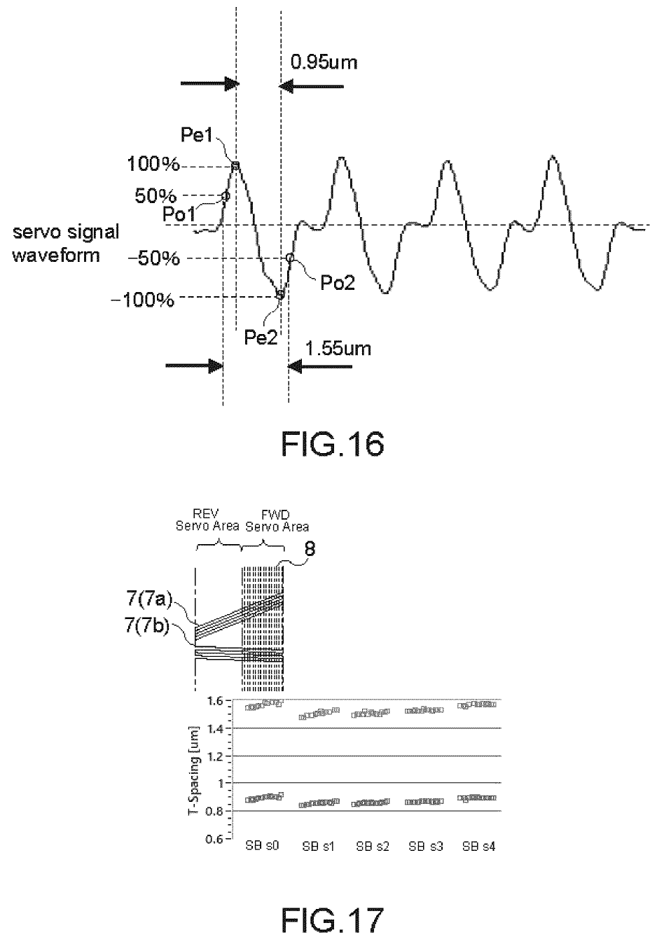

FIG. 16 is a diagram showing the waveform of the servo signal when the servo pattern 7 in the magnetic tape 1 of the type A was read. Note that the horizontal axis in FIG. 16 indicates a time and the vertical axis in FIG. 16 indicates an output value.

The waveform of the servo signal corresponding to one servo pattern 7 is generally Sin wave-like. The waveform of the servo signal has crests on the positive side and troughs on the negative side. A crest on the positive side has a rise portion on the positive side (from the point of the output value 0 to the peak point Pe1 on the positive side) and a fall portion on the positive side (from the peak point Pe1 on the positive side to the point of the output value 0). Meanwhile, a crest on the negative side has a fall portion on the negative side (from the point of the output value 0 to the peak point Pe2 on the negative side) and a rise portion on the negative side (from the peak point Pe2 on the negative side to the point of the output value 0).

The first point Po1 that is one criteria for measuring the width SPW of the servo pattern 7 is set to a point (excluding the peak point Pe1 on the positive side) corresponding to any one of the rise portions of the crests on the positive side in the waveform of the servo signal. Further, the second point Po2 that is the other criteria for measuring the width SPW of the servo pattern 7 is set to a point (excluding the peak point Pe2 on the negative side) corresponding to any one of the rise portions of the troughs on the positive side in the waveform of the servo signal.

Assuming that the output value of the peak point Pe1 on the positive side in the waveform of the servo signal is 100%, the first point Po1 is set to a point (excluding 100%) corresponding to the output value that is a first percentage with respect to the peak point Pe1 on the positive side. Further, when the output value of the peak point Pe2 on the negative side in the waveform of the servo signal is set to −100%, the second point Po2 is set to a point (excluding −100%) corresponding to the output value that is a second percentage with respect to the peak point Pe2 on the negative side.

In this embodiment, the first percentage is set to any value within a first range of 25% or more and 75% or less. Further, in this embodiment, the second percentage is set to any value within a second range of −25% or more and −75% or less.

Further, in this embodiment, the absolute values of the first percentage and the second percentage are set to be the same. Note that the absolute values of the first percentage and the second percentage may be set to be different.

Here, the basis for the lower limits and the upper limits of the first percentage and the second percentage will be described.

As described above, in this embodiment, the magnetic layer 4 of the perpendicularly oriented type is used as the magnetic layer 4. Further, as described above in FIG. 13, in a case where the magnetic layer 4 is the perpendicularly oriented type, the positions of the peak point Pe1 on the positive side and the peak point Pe2 on the negative side in the output waveform of the servo signal are shifted inward from the positions of the both end portions of the servo pattern 7 in the width direction of the servo pattern 7. The higher the perpendicular orientation of the magnetic layer 4 (squareness ratio S1 in the perpendicular direction), the larger this amount of shift.

Therefore, if the perpendicular orientation of the magnetic layer 4 (squareness ratio S1 in the perpendicular direction) is relatively high, it is necessary to set the absolute values of the first percentage and the second percentage to be low. On the other hand, if the perpendicular orientation of the magnetic layer 4 is relatively low, it is necessary to set the absolute values of the first percentage and the second percentage to be high.

For example, when the perpendicular orientation of the magnetic layer 4 (squareness ratio S1 in the perpendicular direction) is set to be the lowest (e.g., non-oriented), if the width SPW of the servo pattern 7 is determined assuming that the absolute values of the first percentage and the second percentage are 75%, it is conceivable to be substantially equal to the width SPW of the actual servo pattern 7. Further, when the perpendicular orientation of the magnetic layer 4 (squareness ratio S1 in the perpendicular direction) is set to be the highest, if the width SPW of the servo pattern 7 is determined assuming that the absolute values of the first percentage and the second percentage are 25%, it is conceivable to be substantially equal to the width SPW of the actual servo pattern 7. That is the basis for the lower limits and the upper limits of the first percentage and the second percentage.

Note that in the example shown in FIG. 16, the first percentage was set to 50% and the second percentage was set to −50%. Then, in the rise portion on the positive side, the detection time difference between the detection time at the first point Po1 at which its output value was 50% with respect to the peak point Pe1 on the positive side and the detection time at which the second point Po2 at which its output value was −50% with respect to the peak point Pe2 on the negative side in the rise portion on the negative side was converted into a distance (the detection time difference×the traveling speed of the magnetic tape 1), and the width SPW of the servo pattern 7 was determined.

The width SPW of the servo pattern 7 determined at this time was about 1.55 μm (average value). That is, the width SPW (about 1.55 μm) of the servo pattern 7 measured in accordance with this embodiment was approximately the same as the width SPW of the servo pattern 7 measured by the MFM (1.5 μm or 1.6 μm). Therefore, it can be seen that in this embodiment, it is possible to accurately determine the width SPW of the actual servo pattern 7.

Note that in the example here, the value obtained by converting the detection time difference between the detection time at the peak point Pe1 on the positive side and the detection time at the peak point Pe2 on the negative side into a distance (the detection time difference×the traveling speed of the magnetic tape 1) was about 0.95 μm (average value) (T (Transition)−spacing).

FIG. 17 is a diagram showing the width SPW of the servo pattern 7 for each servo truck 8 (for each servo trace line) for each servo band s in the magnetic tape 1 of the type A. In FIG. 17, the vertical axis indicates the calculated width SPW of the servo pattern 7 and the horizontal axis indicates the position (i.e., the position of the servo truck 8) in the width direction of the magnetic tape 1 (Y-axis direction).

Each plot on the upper side in FIG. 17 shows the width SPW of the servo pattern 7 in each servo truck 8 in each servo band s that was determined by the measurement method according to this embodiment. Meanwhile, each plot on the lower side in FIG. 17 shows the width SPW of the servo pattern 7 in each servo truck 8 in each servo band s that was determined by the peak-to-peak measurement method (T−spacing).

The width SPW of the servo pattern 7 that was determined by the measurement method according to this embodiment as shown in each plot on the upper side in FIG. 17 was approximately 1.55 μm for each servo truck 8 in each servo band s even though there were slight variations. That is, the width SPW (about 1.55 μm) of the servo pattern 7 measured in accordance with this embodiment was approximately the same as the width SPW of the servo pattern 7 measured by the MEM (1.5 μm or 1.6 μm). Therefore, it can be seen that in this embodiment, it is possible to accurately determine the width SPW of the actual servo pattern 7.

Note that in the example shown in FIG. 17, in the servo pattern 7, the region lower than the center in the width direction of the magnetic tape 1, i.e., in the servo measurement apparatus 100, the width SPW of the servo pattern 7 in a region that was read when the magnetic tape 1 was traveling in the forward direction is shown as a plot. Meanwhile, in the servo pattern 7, actual measurement was performed also with respect to the width SPW of the servo pattern 7 in the region upper than the center in the width direction of the magnetic tape 1, i.e., the region that was read when the magnetic tape 1 was traveling in the reverse direction in the servo measurement apparatus 100. Then, also in this case, the width SPW of the servo pattern 7 was about 1.55 μm.

Note that the width SPW of the servo pattern 7 that was determined by the peak-to-peak measurement method as shown in each plot on the lower side of FIG. 17 (T-spacing) was about 0.95 μm.

### Magnetic Tape 1 of Type B

FIG. 18 is a diagram showing the MFM image of the servo pattern 7 in the magnetic tape 1 of the type B and the magnetic force waveform by the MEM.

Each MFM image shown in FIG. 18 shows servo patterns 7 (servo bursts) on different servo bands s in the magnetic tape 1 of the type B. Each MFM image is an image of 35 μm×35 μm (vertical×horizontal). In the example shown in FIG. 18, in the MFM measurement based on the MFM image and the magnetic force waveform, the width SPW (average value) of the servo pattern 7 of the servo band s0, the servo band s1, the servo band s3, or the servo band s4 was 1.9 μm and the width SPW (average value) of the servo pattern 7 of the servo band s2 was 1.8 μm.

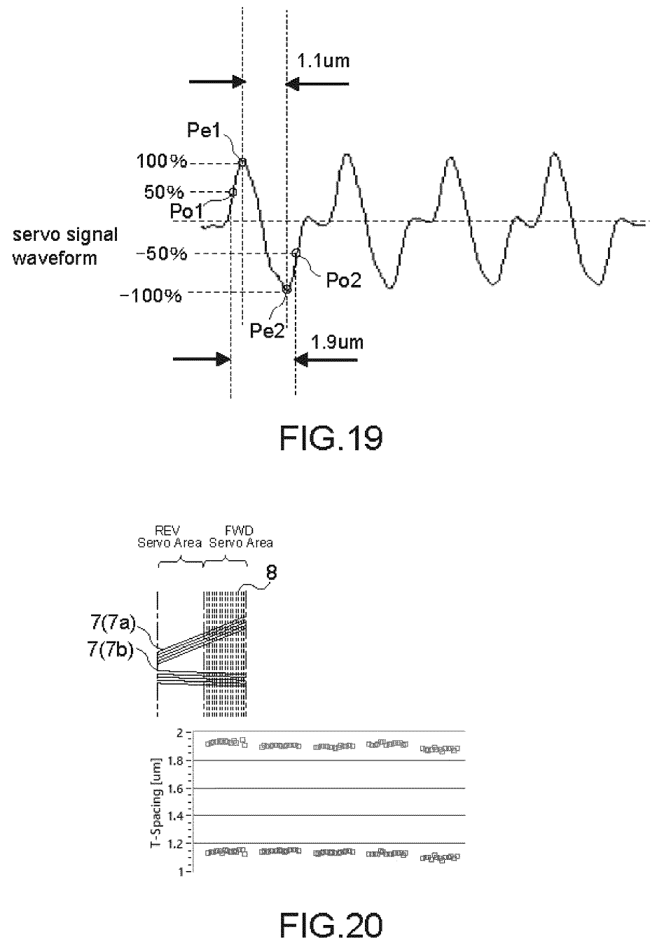

FIG. 19 is a diagram showing the waveform of the servo signal when the servo pattern 7 in the magnetic tape 1 of the type B was read. Note that the horizontal axis in FIG. 19 indicates a time and the vertical axis in FIG. 19 indicates an output value.

Note that in the example shown in FIG. 19, as in FIG. 16, the first percentage was set to 50% and the second percentage was set to −50%. Then, in the rise portion on the positive side, the detection time difference between the detection time at the first point Po1 at which its output value was 50% with respect to the peak point Pe1 on the positive side and a detection time at which the second point Po2 at which its output value was −50% with respect to the peak point Pe2 on the negative side in the rise portion on the negative side was converted into a distance (the detection time difference×the traveling speed of the magnetic tape 1), and the width SPW of the servo pattern 7 was determined.

The width SPW of the servo pattern 7 determined at this time was about 1.9 μm (average value). That is, the width SPW (about 1.9 μm) of the servo pattern 7 measured in accordance with this embodiment was approximately the same as the width SPW of the servo pattern 7 measured by the MFM (1.8 μm or 1.9 μm). Therefore, it can be seen that in this embodiment, it is possible to accurately determine the width SPW of the actual servo pattern 7.

Note that in the example here, the value obtained by converting the detection time difference between the detection time at the peak point Pe1 on the positive side and the detection time at the peak point Pe2 on the negative side into a distance (the detection time difference×the traveling speed of the magnetic tape 1) was about 1.1 μm (T (Transition)−spacing).

FIG. 20 is a diagram showing the width SPW of the servo pattern 7 for each servo truck 8 (for each servo trace line) for each servo band s in the magnetic tape 1 of the type B. In FIG. 20, the vertical axis indicates the calculated width SPW of the servo pattern 7 and the horizontal axis indicates the position (i.e., the position of the servo truck 8) in the width direction of the magnetic tape 1 (Y-axis direction).

Each plot on the upper side in FIG. 20 shows the width SPW of the servo pattern 7 in each servo truck 8 in each servo band s that was determined by the measurement method according to this embodiment. Meanwhile, each plot on the lower side in FIG. 20 shows the width SPW of the servo pattern 7 in each servo truck 8 in each servo band s that was determined by the peak-to-peak measurement method (T−spacing).

The width SPW of the servo pattern 7 that was determined by the measurement method according to this embodiment as shown in each plot on the upper side in FIG. 20 was about 1.9 μm for each servo truck 8 in each servo band s even though there were slight variations. That is, the width SPW (about 1.9 μm) of the servo pattern 7 measured in accordance with this embodiment was approximately the same as the width SPW of the servo pattern 7 measured by the MEM (1.8 μm or 1.9 μm). Therefore, it can be seen that in this embodiment, it is possible to accurately determine the width SPW of the actual servo pattern 7.

Note that in the example shown in FIG. 20, in the servo pattern 7, the region lower than the center in the width direction of the magnetic tape 1, i.e., in the servo measurement apparatus 100, the width SPW of the servo pattern 7 in the region that was read when the magnetic tape 1 was traveling in the forward direction is shown as a plot. Meanwhile, in the servo pattern 7, actual measurement was performed also with respect to the width SPW of the servo pattern 7 in the region upper than the center in the width direction of the magnetic tape 1, i.e., the region that was read when the magnetic tape 1 was traveling in the reverse direction in the servo measurement apparatus 100. Then, also in this case, the width SPW of the servo pattern 7 was about 1.9 μm.

Note that the width SPW of the servo pattern 7 that was determined by the peak-to-peak measurement method as shown in each plot on the lower side of FIG. 20 (T−spacing) was about 1.1 μm.

Matching Degree Between Measurement Method According to this Embodiment and Measurement Method by MFM

Next, a matching degree between the width SPW of the servo pattern 7 measured by the measurement method according to this embodiment and the width SPW of the servo pattern 7 measured by the measurement method in the MFM will be described.

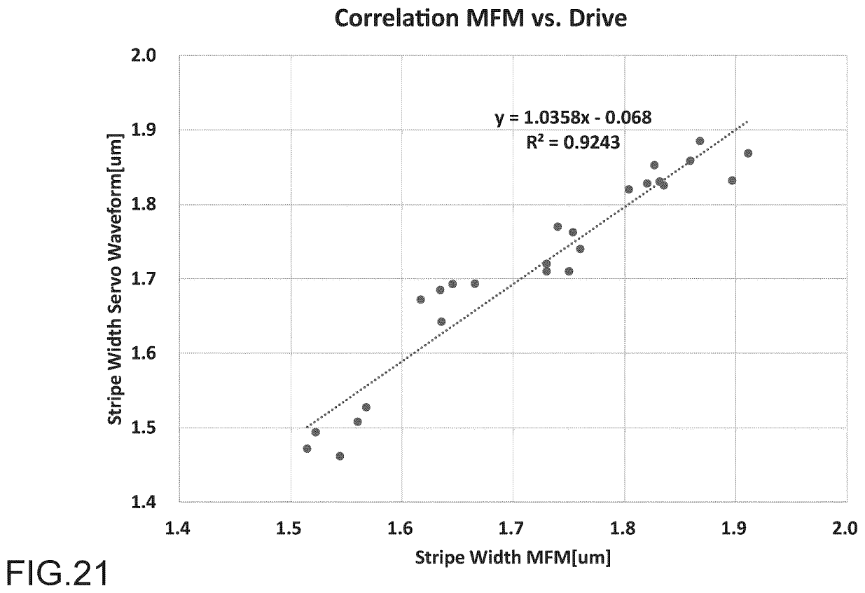

FIG. 21 is a diagram for describing the matching degree between the width SPW of the servo pattern 7 measured by the measurement method according to this embodiment and the width SPW of the servo pattern 7 measured by the measurement method in the MFM. In FIG. 21, the horizontal axis indicates the width SPW of the servo pattern 7 measured by the measurement method in the MEM and the vertical axis indicates the width SPW of the servo pattern 7 measured by the measurement method according to this embodiment.

As measurement conditions of the measurement method according to this embodiment, the following conditions were set. First of all, the old data recording/reproduction apparatus (data write head: non-rotated-type with tilt of 0°) corresponding to LTO-8 was reused as the servo measurement apparatus 100. Further, the traveling speed of the magnetic tape 1 was set to 4 m/s. Further, for the sampling rate, data was collected at 125 MS/s.

Further, waveforms of servo signals at 300 positions (a waveform at one position corresponding to one servo pattern 7) were extracted as samples for one servo truck 8 in one servo band s, and widths SPW of servo patterns 7 were respectively measured with respect to the waveforms at the 300 positions. An average value of the widths SPW of the servo patterns 7 at the 300 positions was determined as the width SPW of the servo pattern 7 in the corresponding servo truck 8 in the corresponding servo band s. That is, an average value for each servo truck 8 was determined as the width SPW of the servo pattern 7.

Note that the first percentage at the first point Po1 was set to 50% and the second percentage at the second point Po2 was set to −50%.

With respect to one servo band s, measurement at 300 positions was performed in each of a total of 26 servo trucks 8, 13 servo trucks 8 used in the forward direction in the traveling direction of the magnetic tape 1 and 13 servo trucks 8 used in the reverse direction in the traveling direction. Then, an average value of the widths SPW of the servo patterns 7 at the 300 positions was determined.

That is, with respect to the five servo bands s, an average value of the widths SPW of the servo patterns 7 at the 300 positions was determined for each of the 26 servo trucks 8. Note that for the width SPW of the servo pattern 7, measurement at a total of 39000 positions (5×26×300) was performed with respect to one magnetic tape 1. The average value of the widths SPW of the servo patterns 7 for each servo truck 8 (average value of 130 (5×26)) was further averaged, and the averaged value was calculated as the width SPW of the servo pattern 7 of the corresponding magnetic tape 1.

Further, the 25 types of magnetic tapes 1 (e.g., with width differences of the servo patterns 7 due to differences of the servo write heads 40) were prepared as magnetic tapes 1. Then, with respect to each of the 25 types of magnetic tapes 1, the width SPW of the servo pattern 7 was measured by the measurement method according to this embodiment.

Further, with respect to the 25 types of magnetic tapes 1, the width SPW of the servo pattern 7 was measured by the measurement method in the MFM.

The 25 plots in FIG. 21 correspond to the 25 types of magnetic tapes 1, respectively. In FIG. 21, a linear regression line for the 25 plots was y=1.0358x−0.068 μm. Further, the coefficient of determination R2 was 0.9243. Therefore, in the measurement method according to this embodiment, it can be seen that the width SPW of the servo pattern 7 can be accurately determined at accuracy equivalent to that of the measurement method by the MFM for any type of magnetic tape 1 (different in the width SPW of the servo pattern 7).

### Measurement Conditions of Width SPW of Servo Pattern 7 by MFM

Next, measurement conditions and the like of the width SPW of the servo pattern 7 by the MFM will be described. For example, SPM Dimension Icon (MFM measurement apparatus) manufactured by Bruker Corporation and its analysis software were used in order to obtain MFM images within the range of 35 μm×35 μm as shown in FIG. 15 and FIG. 18 and widths SPW of the servo patterns 7. Further, SSS-MFM R (manufactured by NANOSENSORS™, probe material: monocrystalline silicon with a magnetic film coating, cantilever length: 225 μm) was used as a cantilever for the MFM measurement. More specific measurement conditions are as follows.

### Measurement Conditions

MFM measurement apparatus: manufactured by Bruker Corporation, SPM Dimension Icon measurement mode MEM
Measurement range: 35 μm×35 μm
Sample lines: 512
Lift scan height: 30 nm
Cantilever: manufactured by NANOSENSORS™, SSS-MEM R

For example, the widths SPW of the servo patterns 7 denoted by the arrows in the upper view of FIG. 14 were each measured with respect to each of the servo bands s0 to s4 by included analysis software from the MEM image obtained under the above-mentioned measurement conditions. Note that in the present specification and in the drawings, when specific numeric values are represented for the measurement values of the widths SPW of the servo patterns 7 by the MEM, they denote values measured under these measurement conditions.

### Processing of Control Unit

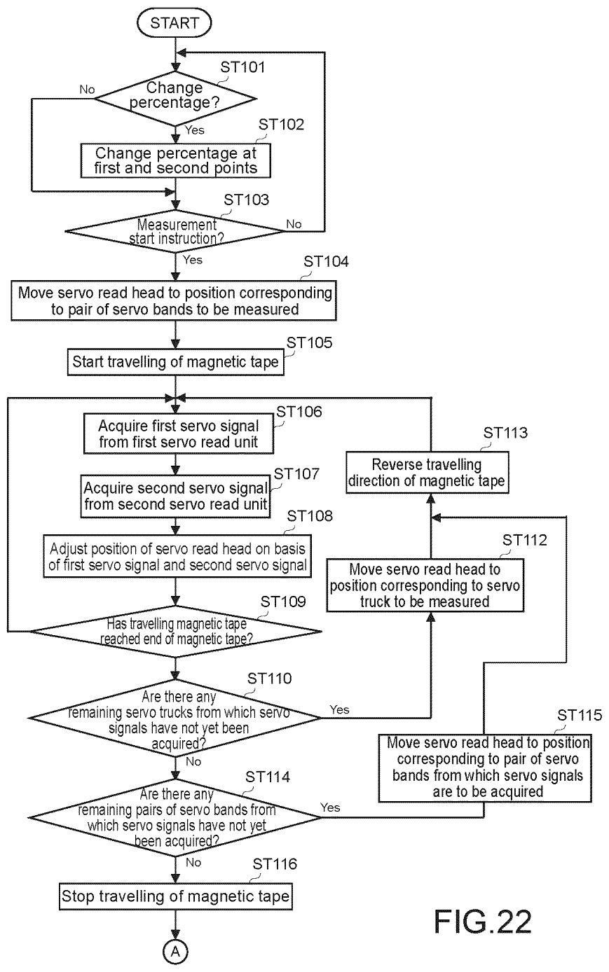

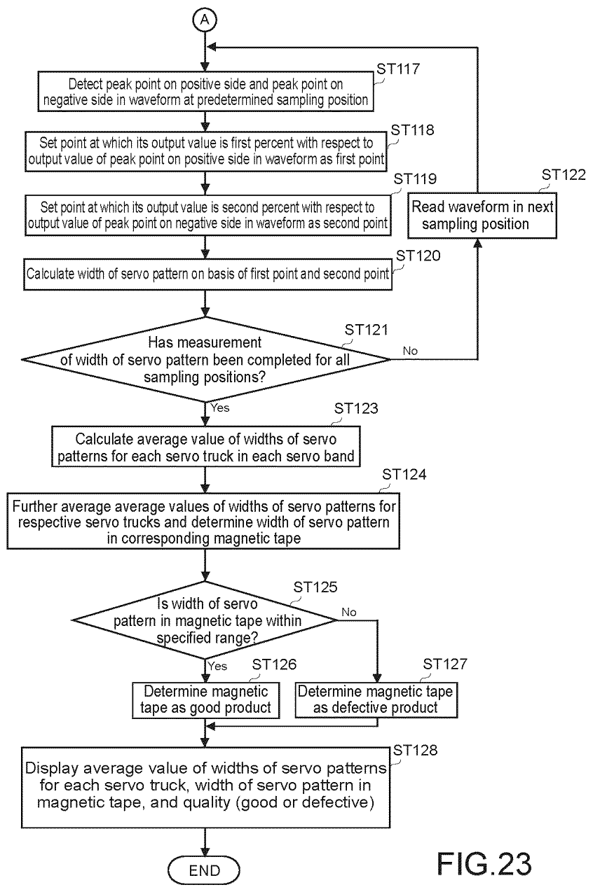

Next, processing of the control unit in the servo measurement apparatus 100 will be described. FIG. 22 and FIG. 23 are flowcharts showing the processing of the control unit.

First of all, the control unit determines whether or not it is necessary to change the first percentage at the first point Po1 and the second percentage at the second point Po2 in accordance with the type of the magnetic tape 1 in the cartridge 10 attached to the servo measurement apparatus 100 (ST101).

In this case, first, the relationship between the type of the magnetic tape 1 and the first percentage and the second percentage (typically, with the same absolute value) is prestored as a table in the storage unit.

Here, as described above, suitable values of the first percentage and the second percentage differ depending on the perpendicular orientation of the magnetic layer 4 (squareness ratio S1 in the perpendicular direction). In addition, the higher the perpendicular orientation of the magnetic layer 4, the lower the first percentage and the second percentage (absolute values). Thus, suitable first percentage and second percentage depending on the type of the magnetic tape 1 (perpendicular orientation) are stored on the table in the storage unit.

That is, in this embodiment, the control unit is capable of automatically changing the first percentage and the second percentage depending on the perpendicular orientation of the magnetic layer 4 in the magnetic tape 1 (squareness ratio S1 in the perpendicular direction). Note that in the example here, a case where both of the first percentage and the second percentage can be changed is described, though one of the first percentage and the second percentage can be changed.

Here, when the first percentage and the second percentage are changed, the positions of the first point Po1 and the second point Po2 are also changed. That is, in this embodiment, the control unit is capable of automatically changing the first point Po1 and the second point Po2 (or may be capable of changing one of the first point Po1 and the second point Po2) depending on the perpendicular orientation of the magnetic layer 4 in the magnetic tape 1 (squareness ratio S1 in the perpendicular direction).

Further, in the example here, a case where the control unit automatically changes the first percentage and the second percentage (first point Po1 and the second point Po2) is described, though the user may be capable of manually changing the first percentage and the second percentage (first point Po1 and the second point Po2).

In a case where it is necessary to change the first percentage and the second percentage (YES in ST101) (e.g., in a case where the magnetic tape 1 (tape cartridge 10) different in the perpendicular orientation from the previous magnetic tape 1 is loaded), the control unit refers to the table stored in the storage unit and changes the first percentage and the second percentage into the corresponding values (ST102).

Meanwhile, in a case where it is unnecessary to change the first percentage and the second percentage (e.g., in a case where the magnetic tape 1 (tape cartridge 10) same in the perpendicular orientation as the previous magnetic tape 1 is loaded), the control unit skips ST102 and shifts to ST103.

In ST103, the control unit determines whether or not the user has input a measurement start instruction. In a case where the user has not input the measurement start instruction (NO in ST103), the control unit returns to ST101.

Meanwhile, in a case where the user has input the measurement start instruction (YES in ST103), the control unit moves the servo read head 20 in the longitudinal direction (Y′-axis direction) of the servo read head 20 (width direction of the magnetic tape 1 (Y-axis direction)) and moves the servo read head 20 to a position corresponding to the pair of servo bands s to be measured (ST104) (see FIG. 11).

The pair of servo bands s to be measured is any one of four pairs, the pair of the servo band s0 and s1, the pair of the servo band s1 and s2, the pair of the servo band s2 and s3, and the pair of the servo band s3 and s4.

Next, the control unit starts traveling of the magnetic tape 1 (ST105). Next, the control unit acquires a first servo signal from the first servo read unit 22a (ST106) and acquires a second servo signal from the second servo read unit 22b (ST107).

Next, the control unit moves the servo read head 20 in the longitudinal direction (Y′-axis direction) of the servo read head 20 and adjusts the position of the servo read head 20 depending on needs to be capable of accurately tracing the servo truck 8 targeted by the first servo read unit 22a and the second servo read unit 22b on the basis of the first servo signal and the second servo signal (position error signals) (ST108).

Next, the control unit determines whether or not the traveling magnetic tape 1 has reached the end of the magnetic tape 1 (ST109). In a case where the traveling magnetic tape 1 has not reached the end of the magnetic tape 1 (NO in ST109), the control unit returns to ST106 and executes the processing of ST106 and the subsequent steps again.

Meanwhile, in a case where the traveling magnetic tape 1 has reached the end of the magnetic tape 1 (YES in ST109), the control unit determines whether or not there is any servo trucks 8 from which the servo signal has not yet been acquired with respect to the corresponding pair of servo bands s (Note that the number of servo trucks 8 from which the servo signals should be acquired for each servo band s is preset (e.g., a total of 26, 13 for the forward direction in the traveling direction of the magnetic tape 1 and 13 for the reverse direction).

With respect to the corresponding pair of servo bands s, in a case where there are any remaining servo trucks 8 from which the servo signal has not yet been acquired (YES in ST110), the control unit moves the servo read head 20 in the longitudinal direction (Y′-axis direction) of the servo read head 20 and moves the servo read head 20 to a position corresponding to the servo truck 8 to be measured (ST112). Then, the control unit reverses the previous traveling direction of the magnetic tape 1 (ST113) and returns to ST106.

Meanwhile, in a case where the servo signals from all servo trucks 8 planned have been acquired with respect to the corresponding pair of servo bands s (NO in ST110), the control unit determines whether or not there are any remaining pairs of servo bands s from which the servo signals have not yet been acquired (ST114).

In a case where there are any remaining pairs of servo bands s from which the servo signals have not yet been acquired (YES in ST114), the control unit moves the servo read head 20 in the longitudinal direction (Y′-axis direction) of the servo read head 20 and moves the servo read head 20 to a position corresponding to the pair of servo bands s from which the servo signals are to be acquired (ST115) (see FIG. 11). Then, the control unit reverses the traveling direction of the magnetic tape 1 (ST113) and returns to ST106.

Note that in this embodiment, servo signals are acquired for each servo truck 8 in each servo band s by the processing shown in ST106 to ST115.

In ST114, in a case where the servo signals have been acquired from all pairs of servo bands s (NO in ST114), the control unit stops the traveling of the magnetic tape 1 (ST116).

Next, the control unit detects the positions of the peak point Pe1 on the positive side and the peak point Pe2 on the negative side with respect to a waveform of a servo signal at a predetermined sampling position (one waveform corresponding to one servo pattern 7) (ST117).

Note that the sampling position and the sampling rate are preset for each servo truck 8 in each servo band s (e.g., 300 positions for one servo truck 8). The sampling position and the sampling rate may be the same or may be different for each servo truck 8 in each servo band s.

Next, the control unit sets a point at which its output value is the first percent (e.g., 50%) with respect to the output value of the peak point Pe1 on the positive side in the rise portion of the crest on the positive side in the waveform of the servo signal as the first point Po1 (ST118).

Next, the control unit sets a point at which its output value is the second percent (e.g., −50%) with respect to the output value of the peak point Pe2 on the negative side in the rise portion of the trough on the negative side in the waveform of the servo signal as the second point Po2 (ST119).

Next, the control unit converts the detection time difference between the detection time at the first point Po1 and the detection time at which the second point Po2 into a distance (the detection time difference×the traveling speed of the magnetic tape 1) and calculates the width SPW of the servo pattern 7 (ST120).

Next, the control unit determines whether or not the measurement of the width SPW of the servo pattern 7 has been completed for all sampling positions (e.g., 23 servo trucks 8 for one servo band s: 300 positions for one servo truck 8: a total of 39000 positions (5×26×300) in the five servo bands s).

In a case where there are any remaining sampling positions at which the width SPW of the servo pattern 7 should be measured (NO in ST121), the control unit reads the waveform of the servo signal corresponding to a next sampling position from the storage unit (ST122) and returns to Step 117.

Meanwhile, in a case where the measurement of the width SPW of the servo pattern 7 has been completed for all sampling positions (YES in ST121), the control unit calculates an average value of the widths SPW of the servo patterns 7 for each servo truck 8 in each servo band s (ST123).

Next, the control unit further averages the average values of the widths SPW of the servo patterns 7 for the respective servo trucks 8 and determines this value as the width SPW of the servo pattern 7 on the corresponding magnetic tape 1 (ST124). Next, the control unit determines whether or not the width SPW of the servo pattern 7 in the magnetic tape 1 is within a specified range (ST125).

The specified range that is a criteria for determining whether or not the width SPW of the servo pattern 7 is accurate may be different for each type of the magnetic tape 1. Here, as described above in FIG. 21 and the like, the width SPW of the servo pattern 7 may be different for each type of the magnetic tape 1. Therefore, in such a case, it is necessary to set the criteria for determining whether or not the width SPW of the servo pattern 7 is accurate to be different.

In this case, for example, the width SPW of the servo pattern 7 is measured for each type of the magnetic tape by the MFM in advance, and the width SPW of the servo pattern 7 measured by the MEM is used as a criteria for the width SPW of the servo pattern 7 of the magnetic tape 1 of the corresponding type.

In this case, the relationship between the type of the magnetic tape and the width SPW of the servo pattern 7 measured by the MFM is stored as a table in the storage unit. Then, the control unit determines whether or not the width SPW of the servo pattern 7 measured in accordance with this embodiment satisfies the criteria (specified range) based on the width SPW of the servo pattern 7 measured by the MFM. Note that the criteria (specified range) needs to at least satisfy a condition for the width SPW of the servo pattern 7 according to the LTO standards.

In a case where the width SPW of the servo pattern 7 is within the specified range (YES in ST125), the control unit determines the magnetic tape 1 as a good product (ST126), and shifts to next ST128.

Meanwhile, in a case where the width SPW of the servo pattern 7 is outside the specified range (NO in ST125), the control unit determines the magnetic tape 1 as a defective product (ST126), and shifts to next ST128. Note that with respect to the magnetic tape 1 determined as a defective product, for example, rewriting of the servo pattern 7 may be performed after it is demagnetized.

In ST128, the control unit displays the average value of the widths SPW of the servo patterns 7 for each servo truck 8 in each servo band s (see FIG. 17 and FIG. 20), the width SPW of the servo pattern 7 in the magnetic tape 1, and the quality (good or defective) of the magnetic tape 1 on the screen of a display unit.

Here, one possible reason the width of the servo band s is outside the specified range is that the servo recording/reproduction apparatus 101 is malfunctioning. Thus, for example, in a case where the situation where a defective product is frequently generated occurs, the user performs the maintenance for the servo recording/reproduction apparatus 101 while checking the display of the display unit in ST128.

Note that the measurement of the width SPW of the servo pattern 7 may be performed for all magnetic tapes 1 (cartridges 10) or may be performed for some samples of all magnetic tapes 1 (cartridges 10).

### Effects, Etc.

As described above, the servo measurement apparatus 100 according to this embodiment calculates the width SPW of the servo pattern 7 on the basis of the first point Po1 and the second point Po2 respectively different from the peak point Pe1 on the positive side in the waveform of the servo signal and the peak point Pe2 on the negative side.

Accordingly, the user can accurately measure the width SPW of the servo pattern 7 easily with the servo measurement apparatus 100. In particular, in this embodiment, the servo measurement apparatus 100 automatically measures the width SPW of the servo pattern 7 by the user loading the cartridge 10 including the magnetic tape 1 into the servo measurement apparatus 100 and starts the measurement of the width SPW of the servo pattern 7.

Further, in this embodiment, the point corresponding to any one of the rise portions of the crests on the positive side in the waveform of the servo signal is set as the first point Po1. Further, the point corresponding to any one of the rise portions of the troughs on the negative side in the waveform of the servo signal is set as the second point Po2.

Accordingly, the first point Po1 and the second point Po2 can be set to suitable positions in the waveform of the servo signal.

Further, in this embodiment, when the output value of the peak point Pe1 on the positive side in the waveform of the servo signal is set to 100%, the point corresponding to the output value, which is the first percentage with respect to the peak point Pe1 on the positive side, is set as the first point Po1. Further, the first percentage is set to the value within the range of 25% or more and 75% or less.

Accordingly, the first point Po1 can be set to a suitable position depending on the perpendicular orientation of the magnetic layer 4 (squareness ratio S1 in the perpendicular direction).

Further, in this embodiment, when the output value of the peak point Pe2 on the negative side in the waveform of the servo signal is set to −100%, the point corresponding to the output value, which is the second percentage with respect to the peak point Pe2 on the negative side, as the second point Po2. Further, the second percentage is set to the value within the range of −25% or more and −75% or less.

Accordingly, the second point Po2 can be set at a suitable position depending on the perpendicular orientation of the magnetic layer 4 (squareness ratio S1 in the perpendicular direction).

Further, the present technology is effective especially when it is used for measuring the width SPW of the servo pattern 7 recorded on the magnetic tape 1 including the magnetic layer 4 of the perpendicularly oriented type (e.g., the squareness ratio S1 in the perpendicular direction is 60% or more). It is because the higher the perpendicular orientation, the larger the amount of inward shift of the position of the peak point Pe1 on the positive side and the position of the peak point Pe2 on the negative side, and in the peak-to-peak measurement method, it is difficult to measure the width SPW of the servo pattern 7.

### Details of Magnetic Tape 1

Subsequently, details of the magnetic tape 1 will be described.

The magnetic tape 1 has a long tape shape and is caused to travel in the longitudinal direction during recording and reproduction of data and the servo pattern 7. Note that the surface of the magnetic layer 4 is a surface on which the servo read head 20 and the servo write head 40 are caused to travel. The magnetic tape 1 is favorably used in a recording/reproduction apparatus including a ring-type head as a recording head. The magnetic tape 1 is favorably used in a recording/reproduction apparatus configured to be capable of recording data with a data track width of 1200 nm or less or 1000 nm or less.

### Base Material 2

As shown in FIG. 2, the base material 2 is a non-magnetic support that supports the underlayer 3 and the magnetic layer 4. The base material 2 has a long film shape. The upper limit value of the average thickness of the base material 2 is favorably 4.4 μm or less, more favorably 4.2 μm or less, still more favorably 4.0 μm or less, and most favorably 3.6 μm or less. When the upper limit value of the average thickness of the base material 2 is 4.4 μm or less, it is possible to make the recording capacity of a single data cartridge 10 larger than that of a general magnetic tape 1. The lower limit value of the average thickness of the base material 2 is favorably 3 μm or more, and more favorably 3.2 μm or more. When the lower limit value of the average thickness of the base material 2 is 3 μm or more, it is possible to suppress a decrease in the strength of the base material 2.

The average thickness of the base material 2 is obtained as follows. First, the magnetic tape 1 having a width of ½ inch is prepared and cut into a length of 250 mm to prepare a sample. Subsequently, the layers of the sample other than the base material 2 (i.e., the underlayer 3, the magnetic layer 4, and the back layer 5) are removed with a solvent such as MEK (methyl ethyl ketone) and dilute hydrochloric acid. Next, a Laser Hologage (LGH-110C) manufactured by Mitutoyo Corporation is used as a measuring apparatus to measure the thickness of the sample (base material 2) at five or more positions, and the measured values are simply averaged (arithmetically averaged) to calculate the average thickness of the base material 2. Note that the measurement positions are randomly selected from the sample.

The base material 2 favorably contains polyester. The Young's modulus of the base material 2 in the longitudinal direction is, for example, 2.5 GPa or more and 14 GPa or less, favorably 2.5 GPa or more and 10 GPa or less, more favorably 2.5 GPa or more and 7.8 GPa or less, and still more favorably 3.0 GPa or more and 7.0 GPa or less.

The polyester includes, for example, at least one of polyethylene terephthalate (PET), polyethylene naphthalate (PEN), polybutylene terephthalate (PBT), polybutylene naphthalate (PBN), polycyclohexylene dimethylene terephthalate (PCT), polyethylene-p-oxybenzoate (PEB), or polyethylene bisphenoxycarboxylate. In the case where the base material 2 contains two or more types of polyesters, the two or more types of polyesters may be mixed, may be copolymerized, or may be stacked. At least one of the terminal or the side chain of the polyester may be modified.

The fact that the base material 2 contains polyester can be confirmed, for example, as follows. First, the magnetic tape 1 is prepared and cut into a length of 250 mm to prepare a sample and then the layers of the sample other than the base material 2 are removed in a way similar to that in the measurement method of the average thickness of the base material 2. Next, the IR spectrum of the sample (base material 2) is acquired using the infrared absorption spectrometry (IR). On the basis of this IR spectrum, the fact that the base material 2 contains polyester can be confirmed.

The base material 2 may further contain, for example, polyamide, polyetheretherketone, polyimide, polyamideimide, polyetheretherketone (PEEK), polyolefins, a cellulose derivative, a vinyl resin, or another polymer resin in addition to polyester, or the polyamide may be aromatic polyamide (aramid). The polyimide may be aromatic polyimide. The polyamideimide may be aromatic polyamideimide.

The base material 2 may contain at least one of polyamide, polyetheretherketone, polyimide, polyamideimide, or polyetheretherketone (PEEK), or may contain a resin such as polyamide, polyimide, polyamideimide, polyolefins, a cellulose derivative, and a vinyl resin as a main component.

In the case where the base material 2 contains a polymer resin other than polyester, the base material 2 favorably contains polyester as a main component. Here, the main component means the component with the highest content (mass ratio), of the polymer resins contained in the base material 2. In the case where the base material 2 contains a polymer resin other than polyester, the polyester and the polymer resin other than the polyester may be mixed or may be copolymerized.

The base material 2 may be biaxially stretched in the longitudinal direction and the width direction. The polymer resin contained in the base material 2 is favorably oriented in an oblique direction with respect to the width direction of the base material 2.

### Magnetic Layer 4

The magnetic layer 4 is a recording layer for recording a signal with a magnetization pattern. The magnetic layer 4 may be a recording layer of a vertical recording type or may be a recording layer of a longitudinal recording type. The magnetic layer 4 contains, for example, a magnetic powder, a binder, and a lubricant. The magnetic layer 4 may further contain at least one additive of an antistatic agent, an abrasive, a curing agent, a rust inhibitor, a non-magnetic reinforcing particle, or the like as necessary. The magnetic layer 4 does not necessarily need to include a coating film of a magnetic material and may include a sputtering film or a deposition film of a magnetic material.

An arithmetic average roughness Ra of the surface of the magnetic layer 4 is 2.0 nm or less, favorably 1.8 nm or less, and more favorably 1.6 nm or less. When the arithmetic average roughness Ra is 2.0 nm or less, since the output reduction due to spacing loss can be suppressed, excellent electromagnetic conversion characteristics can be achieved. The lower limit value of the arithmetic average roughness Ra of the surface of the magnetic layer 4 is favorably 1.0 nm or more, and more favorably 1.2 nm or more. When the lower limit value of the arithmetic average roughness Ra of the surface of the magnetic layer 4 is 1.0 nm or more, it is possible to suppress deterioration of the traveling property due to an increase in friction.

The arithmetic average roughness Ra can be obtained as follows. First, the surface of the magnetic layer 4 is observed by an AFM (Atomic Force Microscope) to obtain an AFM image of 40 μm×40 μm. SPM Dimension Icon manufactured by BRUKER is used as the AFM, one formed of silicon single crystal is used as a cantilever (Note 1), and measurement is performed by tuning at 200 to 400 Hz as the tapping frequency. Next, the AFM image is divided into 512×512 (=262, 144) measurement points, a height Z (i) (i: measurement point numbers, i=1 to 262, 144) is measured at each measurement point, and the heights Z (i) at the respective measurement points are simply averaged (arithmetically averaged) to obtain an average height (average surface) Zave (=(Z(1)+Z(2)+ . . . +Z (262, 144))/262, 144). Subsequently, a deviation Z″(i) from an average center line at each measurement point (=Z(i)−Zave) is obtained to calculate the arithmetic average roughness Ra [nm] (=(Z″(1)+Z″(2)+ . . . +Z″(262, 144))/262, 144). At this time, one that has been subjected to filtering by second-order Flatten and third-order planefit in XY as image processing is used as data.

Note 1: SPM probe NCH of a normal type, PointProbe manufactured by Nano World

L (cantilever length)=125 μm

The upper limit value of an average thickness tₘ of the magnetic layer 4 is 80 nm or less, favorably 70 nm or less, and more favorably 50 nm or less. When the upper limit value of the average thickness tₘ of the magnetic layer 4 is 80 nm or less, the influence of the demagnetizing field can be reduced in the case where a ring-type head is used as the recording head, and thus, more excellent electromagnetic conversion characteristics can be achieved.

The lower limit value of the average thickness tₘ of the magnetic layer 4 is favorably 35 nm or more. When the lower limit value of the average thickness tₘ of the magnetic layer 4 is 35 nm or more, the output can be ensured in the case where an MR-type head is used as the reproduction head, and thus, more excellent electromagnetic conversion characteristics can be achieved.

The average thickness tₘ of the magnetic layer 4 is obtained as follows. First, the magnetic tape 1 housed in the cartridge 10 is unwound, and the magnetic tape 1 is cut at three positions of 10 m, 30 m, and 50 m from one end thereof on the outermost periphery side to prepare three samples. Subsequently, each sample (magnetic tape 1 to be measured) is processed by an FIB method or the like to obtain a slice. In the case of using an FIB method, a carbon layer and a tungsten layer are formed as protective films as pre-processing for observing a TEM image of a cross section described below. The carbon layer is formed on each of the surfaces of the magnetic tape 1 on the side of the magnetic layer 4 and on the side of the back layer 5 by a vapor deposition method and the tungsten layer is further formed on the surface on the side of the magnetic layer 4 by a vapor deposition method or a sputtering method. The slicing is performed along the longitudinal direction of the magnetic tape 1 (longitudinal direction). That is, the slicing forms a cross section parallel to both the longitudinal direction and the thickness direction of the magnetic tape 1.

The cross section described above of the obtained sliced sample is observed through a transmission electron microscope (TEM) under the following conditions to obtain a TEM image of each sliced sample. Note that the magnification and the acceleration voltage may be adjusted as appropriate in accordance with the type of apparatus.
Apparatus: TEM (H9000NAR manufactured by Hitachi, Ltd.)
Acceleration voltage: 300 kV
Magnification: 100,000 times

Next, the thickness of the magnetic layer 4 is measured in at least ten or more positions of each sliced sample using the obtained TEM image of each sliced sample. Note that since the slicing is performed along the longitudinal direction of the magnetic tape 1 as described above, the 10 measurement positions of each sliced sample are randomly selected from the test piece such that they are different positions in the longitudinal direction of the magnetic tape 1. The average value obtained simply averaging (arithmetically averaging) the obtained measured values of each sliced sample (thickness of the magnetic layer 4 at a total of 30 points) is used as the average thickness tₘ [nm] of the magnetic layer 4.

### Magnetic Powder

The magnetic powder includes a plurality of magnetic particles. The magnetic particles are, for example, particles including hexagonal ferrite (hereinafter, referred to as “hexagonal ferrite particles”.), particles including epsilon-type iron oxide (¿-iron oxide) (hereinafter, referred to as “s-iron oxide particles”.), or particles including Co-containing spinel ferrite (hereinafter, referred to as “cobalt ferrite particles”.). The magnetic powder favorably has magnetocrystalline anisotropy and uniaxial anisotropy.

### Hexagonal Ferrite Particles

Each of the hexagonal ferrite particles has a plate shape such as a hexagonal plate shape or a columnar shape such as a hexagonal columnar shape (where the thickness or height is smaller than the major axis of the plate surface or bottom surface). In the present specification, the hexagonal plate shape includes a substantially hexagonal plate shape. The hexagonal ferrite contains favorably at least one of Ba, Sr, Pb, or Ca, and more favorably at least one of Ba or Sr. The hexagonal ferrite may specifically be barium ferrite or strontium ferrite, for example. The barium ferrite may further contain at least one of Sr, Pb, or Ca in addiction to Ba. The strontium ferrite may further contain at least one of Ba, Pb, or Ca in addition to Sr.

More specifically, the hexagonal ferrite has an average composition represented by a general formula MFe₁₂O₁₉. However, M is, for example, at least one metal of Ba, Sr, Pb, or Ca, and favorably at least one metal of Ba or Sr. M may be a combination of Ba and one or more metals selected from the group consisting of Sr, Pb, and Ca. Further, M may be a combination of Sr and one or more metals selected from the group consisting of Ba, Pb, and Ca. In the general formula described above, some Fes may be substituted by another metal element other than Fe.

In the case where the magnetic powder includes a powder of hexagonal ferrite particles, the average particle size of the magnetic powder is favorably 13 nm or more and 22 nm or less, more favorably 13 nm or more and 19 nm or less, still more favorably 13 nm or more and 18 nm or less, particularly favorably 14 nm or more and 17 nm or less, most favorably 14 nm or more and 16 nm or less. When the average particle size of the magnetic powder is 22 nm or less, more excellent electromagnetic conversion characteristics (e.g., SNR) can be achieved in the magnetic tape 1 having high recording density. Meanwhile, when the average particle size of the magnetic powder is 13 nm or more, the dispersibility of the magnetic powder is further improved and further excellent electromagnetic conversion characteristics (e.g., SNR) can be achieved.

In the case where the magnetic powder includes a powder of hexagonal ferrite particles, the average aspect ratio of the magnetic powder is favorably 1.0 or more and 3.0 or less, more favorably 1.5 or more and 2.8 or less, and still more favorably 1.8 or more and 2.7 or less. When the average aspect ratio of the magnetic powder is within a range of 1.0 or more and 3.0 or less, agglomeration of the magnetic powder can be suppressed. Further, the resistance applied to the magnetic powder when vertically orienting the magnetic powder in the process of forming the magnetic layer 4 can be suppressed. Therefore, it is possible to improve the perpendicular orientation property of the magnetic powder.

In the case where the magnetic powder includes a powder of hexagonal ferrite particles, the average particle size and the average aspect ratio of the magnetic powder are obtained as follows. First, the magnetic tape 1 to be measured is processed by an FIB method or the like to obtain a slice. In the case of using an FIB method, a carbon layer and a tungsten layer are formed as protective films as pre-processing for observing a TEM image of a cross section described below. The carbon layer is formed on each of the surfaces of the magnetic tape 1 on the side of the magnetic layer 4 and on the side of the back layer 5 by a vapor deposition method and the tungsten layer is further formed on the surface on the side of the magnetic layer 4 by a vapor deposition method or a sputtering method. The slicing is performed along the longitudinal direction of the magnetic tape 1 (longitudinal direction). That is, the slicing forms a cross section parallel to both the longitudinal direction and the thickness direction of the magnetic tape 1.

A transmission electron microscope (H-9500 manufactured by Hitachi High-Technologies Corporation) is used for observing the cross section described above of the obtained sliced sample such that the entire magnetic layer 4 is included with respect to the thickness direction of the magnetic layer 4 at the acceleration voltage: 200 kV and the total magnification: 500,000 times to take a TEM photograph. The number of TEM photographs to be prepared is the number that 50 particles for which a plate diameter DB and a plate thickness DA (see FIG. 34) shown below can be measured can be extracted.

In the present specification, regarding the size of the hexagonal ferrite particles (hereinafter, referred to as a “particle size”.), in the case where the shape of the particle observed in the TEM photograph described above is a plate shape or a columnar shape (where the thickness or height is smaller than the major axis of the plate surface or bottom surface.), the major axis of the plate surface or bottom surface is used as the value of the plate diameter DB. The thickness or height of the particle observed in the TEM photograph described above is used as the value of the plate thickness DA. In the case where the thickness or height of the particle is not constant in one particle, the maximum thickness or height of the particle is used as the plate thickness DA.

Next, 50 particles to be extracted from the taken TEM photograph are selected on the basis of the following criteria. Particles partially protruding outside the field of view of the TEM photograph are not measured, and particles with clear contours and present in isolation are measured. In the case where particles overlap, each of particles is measured as a single particle if the boundary between the particles is clear and the shape of the entire particle is determinable. However, particles whose boundaries are unclear and whose overall shape is indeterminable are not measured because the shape of the particle is indeterminable.

The plate thickness DA of each of the selected 50 particles is measured. The plate thicknesses DA obtained in this way are simply averaged (arithmetically averaged) to obtain an average plate thickness DAₐᵥₑ. The average plate thickness DAₐᵥₑ is the average particle plate thickness. Subsequently, the plate diameter DB of each magnetic powder is measured. In order to measure the plate diameter DB of the particle, 50 particles whose plate diameter DB can be clearly observed are selected from the taken TEM photograph. The plate diameter DB of each of the selected 50 particles is measured. The plate diameters DB obtained in this way are simply averaged (arithmetically averaged) to obtain an average plate diameter DBₐᵥₑ. The average plate diameter DBₐᵥₑ is the average particle size. Then, an average aspect ratio (DBₐᵥₑ/DAₐᵥₑ) of the particles is obtained on the basis of the average plate thickness DAₐᵥₑ and the average plate diameter DBₐᵥₑ.

In the case where the magnetic powder includes a powder of hexagonal ferrite particles, the average particle volume of the magnetic powder is favorably 500 nm³ or more and 2500 nm³ or less, more favorably 500 nm³ or more and 1600 nm³ or less, still more favorably 500 nm³ or more and 1500 nm³ or less, particularly favorably 600 nm³ or more and 1200 nm³ or less, and most favorably 600 nm³ or more and 1000 nm³ or less. When the average particle volume of the magnetic powder is 2500 nm³ or less, an effect similar to that in the case where the average particle size of the magnetic powder is 22 nm or less can be achieved. Meanwhile, when the average particle volume of the magnetic powder is 500 nm³ or more, an effect similar to that in the case where the average particle size of the magnetic powder is 13 nm or more can be achieved.

The average particle volume of the magnetic powder is obtained as follows. First, as described above with respect to the method of calculating the average particle size of the magnetic powder, the average major-axis length DAₐᵥₑ and the average plate diameter DBₐᵥₑ are obtained. Next, an average volume V of the magnetic powder is obtained in accordance with the following formula.

$$V = \frac{3 \sqrt{3}}{8} \times D {A}_{a v e} \times D {B}_{ave} \times D {B}_{a v e} \qquad ( Math . 1 )$$

### ε-Iron Oxide Particles

The ε-iron oxide particles are hard magnetic particles capable of achieving a high coercive force even as minute particles. The ε-iron oxide particles each have a spherical shape or a cubic shape. In the present specification, the spherical shape includes a substantially spherical shape. Further, the cubic shape includes a substantially cubic shape. Since the s-iron oxide particles have the shape as described above, it is possible to reduce the contact area of the particles in the thickness direction of the magnetic tape 1 and suppress agglomeration of the particles in the case where the ε-iron oxide particles are used as the magnetic particles, as compared with the case where barium ferrite particles having a hexagonal plate shape are used as the magnetic particles. Therefore, it is possible to enhance the dispersibility of the magnetic powder and achieve further excellent electromagnetic conversion characteristics (e.g., SNR).

Each of the ε-iron oxide particles has a composite particle structure such as a core-shell structure, a Janus structure, and a surface-joined structure.

Part of the composite structure contains ε-iron oxide. The s-iron oxide is favorably one having ε-Fe₂O₃ crystals as the main phase, and more favorably one formed of single-phase ε-Fe₂O₃.

In other parts of the composite structure, it is favorable that the ε-iron oxide part and the other parts are exchange-coupled and behave like a single particle as the magnetic properties.

The other parts are favorably the soft magnetic layer 4, and contains a soft magnetic material such as α-Fe, a Ni—Fe alloy, and an Fe—Si—Al alloy. The x-Fe may be obtained by reducing the ε-iron oxide contained in the core portion. Alternatively, even if it is not soft magnetic, it may have higher σs and lower Hc than ε-iron oxide.

The ε-iron oxide particles may include an additive instead of the above structure or may include an additive while having the above structure. In this case, some Fes of the ε-iron oxide particles are substituted by the additive. Also with the ε-iron oxide particles including the additive, a coercive force Hc of the entire ε-iron oxide particles can be adjusted to the coercive force Hc suitable for recording, and thus, it is possible to improve the easiness of recording. The additive is a metal element other than iron, favorably a trivalent metal element, more favorably at least one of Al, Ga, or In, and still more favorably at least one of Al or Ga.

Specifically, the ε-iron oxide including the additive is ε-Fe₂₋ₓMₓO₃ crystals. The additive includes a metal element other than iron, more favorably at least one of Al (aluminum), Ga (gallium), in (indium), Co (cobalt), Mn (manganese), Zr (zirconium), Hf (hafnium), Cs (cesium) and Ti (titanium), Sm (samarium), Nd (neodymium), Pr (praseodymium), or Tb (terbium).

In the case where the magnetic powder includes the ε-iron oxide particles, the average particle size of the magnetic powder is favorably 10 nm or more and 20 nm or less, more favorably 10 nm or more and 18 nm or less, still more favorably 10 nm or more and 16 nm or less, particularly favorably 10 nm or more and 15 nm or less, and most favorably 10 nm or more and 14 nm or less. In the magnetic tape 1, a region having a size of ½ of the recording wavelength is an actual magnetized region. For this reason, by setting the average particle size of the magnetic powder to half or less of the shortest recording wavelength, it is possible to achieve more excellent electromagnetic conversion characteristics (e.g., SNR). Therefore, when the average particle size of the magnetic powder is 20 nm or less, it is possible to achieve more excellent electromagnetic conversion characteristics (e.g., SNR) in the magnetic tape 1 having high recording density (e.g., the magnetic tape 1 configured to be capable of recording a signal at the shortest recording wavelength of 40 nm or less). Meanwhile, when the average particle size of the magnetic powder is 10 nm or more, the dispersibility of the magnetic powder is further improved and it is possible to achieve more excellent electromagnetic conversion characteristics (e.g., SNR).

In the case where the magnetic powder includes the ε-iron oxide particles, the average aspect ratio of the magnetic powder is favorably 1.0 or more and 3.0 or less, more favorably 1.0 or more and 2.5 or less, still more favorably 1.0 or more and 2.1 or less, and particularly favorably 1.0 or more and 1.8 or less. When the average aspect ratio of the magnetic powder is within the range of 1.0 or more and 3.0 or less, it is possible to suppress agglomeration of the magnetic powder. Further, the resistance applied to the magnetic powder when vertically orienting the magnetic powder in the process of forming the magnetic layer 4 can be suppressed. Therefore, it is possible to improve the perpendicular orientation property of the magnetic powder.

In the case where the magnetic powder includes a powder of ε-iron oxide particles, the average particle size and the average aspect ratio of the magnetic powder are obtained as follows. First, the magnetic tape 1 to be measured is processed by an FIB (Focused Ion Beam) method or the like to obtain a slice. In the case of using an FIB method, a carbon layer and a tungsten layer are formed as protective layers as pre-processing for observing a TEM image of a cross section described below. The carbon layer is formed on each of the surfaces of the magnetic tape 1 on the side of the magnetic layer 4 and on the side of the back layer 5 by a vapor deposition method and the tungsten layer is further formed on the surface on the side of the magnetic layer 4 by a vapor deposition method or a sputtering method. The slicing is performed along the longitudinal direction of the magnetic tape 1 (longitudinal direction). That is, the slicing forms a cross section parallel to both the longitudinal direction and the thickness direction of the magnetic tape 1.

A transmission electron microscope (H-9500 manufactured by Hitachi High-Technologies Corporation) is used for observing the cross section described above of the obtained sliced sample such that the entire magnetic layer 4 is included with respect to the thickness direction of the magnetic layer 4 at the acceleration voltage: 200 kV and the total magnification: 500,000 times to take a TEM photograph. Next, 50 particles, which have the shape that can be clearly observed, are selected from the taken TEM photograph, and a major-axis length DL and a minor-axis length DS of each particle are measured. Here, the major-axis length DL means the maximum one (so-called maximum Feret diameter) of distances between two parallel lines drawn at any angle so as to be in contact with the outline of each particle. Meanwhile, the minor-axis length DS means the maximum one of particle lengths in a direction orthogonal to a major axis (DL) of the particle. Subsequently, the measured major-axis lengths DL of the 50 particles are simply averaged (arithmetically averaged) to obtain an average major-axis length DLₐᵥₑ. The average major-axis length DLₐᵥₑ obtained in this way is used as the average particle size of the magnetic powder. Further, the measured minor-axis length DS of the 50 particles are simply averaged (arithmetically averaged) to obtain an average minor-axis length DSₐᵥₑ. Then, an average aspect ratio (DLₐᵥₑ/DSₐᵥₑ) of the particle is obtained on the basis of the average major-axis length DLₐᵥₑ and the average minor-axis length DSₐᵥₑ.

In the case where the magnetic powder includes the ε-iron oxide particles, the average particle volume of the magnetic powder is favorably 500 nm³ or more and 4000 nm³ or less, more favorably 500 nm³ or more and 3000 nm³ or less, still more favorably 500 nm³ or more and 2000 nm³ or less, particularly favorably 600 nm³ or more and 1600 nm³ or less, and most favorably 600 nm³ or more and 1300 nm³ or less. Since noise of the magnetic tape 1 is generally inversely proportional to the square root of the number of particles (i.e., proportional to the square root of the particle volume), it is possible to achieve more excellent electromagnetic conversion characteristics (e.g., SNR) by making the particle volume smaller. Therefore, when the average particle volume of the magnetic powder is 4000 nm³ or less, it is possible to achieve more excellent electromagnetic conversion characteristics (e.g., SNR) as in the case where the average particle size of the magnetic powder is 20 nm or less. Meanwhile, when the average particle volume of the magnetic powder is 500 nm³ or more, an effect similar to that in the case where the average particle size of the magnetic powder is 10 nm or more can be achieved.

In the case where the ε-iron oxide particles each have a spherical shape, the average particle volume of the magnetic powder is obtained as follows. First, the average major-axis length DLₐᵥₑ is obtained in a way similar to the method of calculating the average particle size of the magnetic powder described above. Next, the average volume V of the magnetic powder is obtained in accordance with the following formula.

V=(π/6)×DLₐᵥₑ³

In the case where the ε-iron oxide particles each have a cubic shape, the average volume of the magnetic powder can be obtained as follows. The magnetic tape 1 is processed by an FIB (Focused Ion Beam) method or the like to obtain a slice. In the case of using an FIB method, a carbon film and a tungsten thin film are formed as protective films as pre-processing for observing a TEM image of a cross section described below. The carbon film is formed on each of the surfaces of the magnetic tape 1 on the side of the magnetic layer 4 and on the side of the back layer 5 by a vapor deposition method and the tungsten thin film is further formed on the surface on the side of the magnetic layer by a vapor deposition method or a sputtering method. The slicing is performed along the longitudinal direction of the magnetic tape 1 (longitudinal direction). That is, the slicing forms a cross section parallel to both the longitudinal direction and the thickness direction of the magnetic tape 1.

A transmission electron microscope (H-9500 manufactured by Hitachi High-Technologies Corporation) is used for observing the cross section of the obtained sliced sample such that the magnetic layer 4 is included with respect to the thickness direction of the magnetic layer 4 at the acceleration voltage: 200 kV and the total magnification: 500,000 times to take a TEM photograph. Note that the magnification and the acceleration voltage may be adjusted as appropriate in accordance with the type of apparatus. Next, 50 particles, which have a clear shape, are selected from the taken TEM photograph, and a length DC of a side of each particle is measured. Subsequently, the measured lengths DC of the 50 particles are simply averaged (arithmetically averaged) to obtain an average side length DCₐᵥₑ. Next, an average volume Vₐᵥₑ (particle volume) of the magnetic powder is obtained on the basis of the following formula by using the average side length DCₐᵥₑ.

Vₐᵥₑ=DCₐᵥₑ³

### Cobalt Ferrite Particles

It is favorable that the cobalt ferrite particles each have uniaxial crystal anisotropy. Since the cobalt ferrite particle has uniaxial crystal anisotropy, it is possible to make the magnetic powder preferentially crystal-oriented in the thickness direction (vertical direction) of the magnetic tape 1. The cobalt ferrite particle has, for example, a cubic shape. In the present specification, the cubic shape includes a substantially cubic shape. The Co-containing spinel ferrite may further contain at least one of Ni, Mn, Al, Cu, or Zn in addition to Co.

The Co-containing spinel ferrite has an average composition represented by the following formula, for example.

CoₓM_{y}Fe₂O_{z}

(where M represents, for example, at least one metal of Ni, Mn, Al, Cu, or Zn. x represents a value in a range of 0.4≤x≤1.0. y represents a value in a range of 0≤y≤0.3. However, x and y satisfy the relationship of (x+y)≤1.0. z represents a value in a range of 3≤z≤4. Some Fes may be substituted by another metal element.)

In the case where the magnetic powder includes a powder of cobalt ferrite particles, the average particle size of the magnetic powder is favorably 8 nm or more and 16 nm or less, more favorably 8 nm or more and 13 nm or less, and still more favorably 8 nm or more and 10 nm or less. When the average particle size of the magnetic powder is 16 nm or less, it is possible to achieve more excellent electromagnetic conversion characteristics (e.g., SNR) in the magnetic tape 1 having high recording density. Meanwhile, when the average particle size of the magnetic powder is 8 nm or more, the dispersibility of the magnetic powder is further improved, and it is possible to achieve more excellent electromagnetic conversion characteristics (e.g., SNR). The method of calculating the average particle size of the magnetic powder is similar to the method of calculating the average particle size of the magnetic powder in the case where the magnetic powder includes a powder of the ε-iron oxide particles.

In the case where the magnetic powder includes a powder of cobalt ferrite particles, the average aspect ratio of the magnetic powder is favorably 1.0 or more and 3.0 or less, more favorably 1.0 or more and 2.5 or less, still more favorably 1.0 or more and 2.1 or less, and particularly favorably 1.0 or more and 1.8 or less. When the average aspect ratio of the magnetic powder is within the range of 1.0 or more and 3.0 or less, it is possible to suppress agglomeration of the magnetic powder. Further, the resistance applied to the magnetic powder when vertically orienting the magnetic powder in the process of forming the magnetic layer 4 can be suppressed. Therefore, it is possible to improve the perpendicular orientation property of the magnetic powder. The method of calculating the average aspect ratio of the magnetic powder is similar to the method of calculating the average aspect ratio of the magnetic powder in the case where the magnetic powder includes a powder of the ε-iron oxide particles.

In the case where the magnetic powder includes a powder of cobalt ferrite particles, the average particle volume of the magnetic powder is favorably 500 nm³ or more and 4000 nm³ or less, more favorably 600 nm³ or more and 2000 nm³ or less, and still more favorably 600 nm³ or more and 1000 nm³ or less. When the average particle volume of the magnetic powder is 4000 nm³ or less, an effect similar to that in the case where the average particle size of the magnetic powder is 16 nm or less can be achieved. Meanwhile, when the average particle volume of the magnetic powder is 500 nm³ or more, an effect similar to that in the case where the average particle size of the magnetic powder is 8 nm or more can be achieved. The method of calculating the average particle volume of the magnetic powder is similar to the method of calculating the average particle volume in the case where the ε-iron oxide particle has a cubic shape.

### Binder

Examples of the binder include a thermoplastic resin, a thermosetting resin, and a reactive resin. Examples of the thermoplastic resin include vinyl chloride, vinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-acrylonitrile copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene butadiene copolymer, a polyurethane resin, a polyester resin, an amino resin, and synthetic rubber.

Examples of the thermosetting resin include a phenolic resin, an epoxy resin, a polyurethane curable resin, a urea resin, a melamine resin, an alkyd resin, a silicone resin, a polyamine resin, and a urea-formaldehyde resin.

For the purpose of improving the dispersibility of the magnetic powder, —SO₃M, —OSO₃M, —COOM, P═O(OM)₂ (where M represents a hydrogen atom or an alkali metal such as lithium, potassium, and sodium), a side chain amine having a terminal group represented by —NR1R2, —NR1R2R3⁺X⁻, a main chain amine represented by >NR1R2⁺X⁻ (where R1, R2, and R3 each represent a hydrogen atom or a hydrocarbon group, and X-represents a halogen element ion such as fluorine, chlorine, bromine, and iodine, an inorganic ion, or an organic ion.), and a polar functional group such as —OH, —SH, —CN, and an epoxy group may be introduced into all the binders described above. The amount of the polar functional groups introduced into the binders is favorably 10⁻¹ to 10⁻⁸ mol/g, and more favorably 10⁻² to 10⁻⁶ mol/g.

### Lubricant

The lubricant contains, for example, at least one of a fatty acid or a fatty acid ester, and favorably both a fatty acid and a fatty acid ester. Containing a lubricant in the magnetic layer 4, particularly, containing both a fatty acid and a fatty acid ester in the magnetic layer 4, contributes to improving the traveling stability of the magnetic tape 1. Particularly, when the magnetic layer 4 contains a lubricant and has a pore, favorable traveling stability can be achieved. It is conceivable that the improvement in the traveling stability can be achieved because the dynamic friction coefficient of the surface of the magnetic tape 1 on the side of the magnetic layer 4 is adjusted to the value suitable for traveling of the magnetic tape 1 by the lubricant described above.

The fatty acid may favorably be a compound represented by the following general formula (1) or (2). For example, one of the compound represented by the following general formula (1) and the compound represented by the general formula (2) may be contained as a fatty acid, or both of them may be contained.

Further, the fatty acid ester may favorably be a compound represented by the following general formula (3) or (4). For example, one of the compound represented by the following general formula (3) and the compound represented by the general formula (4) may be contained as the fatty acid ester, or both of them may be contained.

When the lubricant contains one or both of the compound represented by the general formula (1) and the compound represented by the general formula (2) and one or both of the compound represented by the general formula (3) and the compound represented by the general formula (4), it is possible to suppress an increase in dynamic friction coefficient due to repeated recording or reproduction of the magnetic tape 1.

CH₃(CH₂)ₖCOOH (1)

(Note that in the general formula (1), k represents an integer selected from a range of 14 or more and 22 or less, and more favorably a range of 14 or more and 18 or less.)

CH₃(CH₂)ₙCH═CH(CH₂)ₘCOOH (2)

(Note that in the general formula (2), the sum of n and m is an integer selected from a range of 12 or more and 20 or less, and more favorably a range of 14 or more and 18 or less.)

CH₃(CH₂)ₚCOO(CH₂)_{q}CH₃ (3)

(Note that in the general formula (3), p represents an integer selected from a range of 14 or more and 22 or less, and more favorably a range of 14 or more and 18 or less, and q represents an integer selected from a range of 2 or more and 5 or less, and more favorably a range of 2 or more and 4 or less.)

CH₃(CH₂)ᵣCOO—(CH₂)ₛCH(CH₃)₂ (4)

(Note that in the general formula (4), r represents an integer selected from a range of 14 or more and 22 or less, and s represents an integer selected from a range of 1 or more and 3 or less.)

CH₃(CH₂)ᵣCOO—CH(CH₃)(CH₂)ₛCH(CH₃) (5)

(Note that in the general formula (5), r represents an integer selected from a range of 14 or more and 22 or less, an s represents an integer selected from a range of 1 or more and 3 or less.)

### Antistatic Agent

Examples of the antistatic agent include carbon black, natural surfactant, nonionic surfactant, and cationic surfactant.

### Abrasive

Examples of the abrasive include α-alumina, β-alumina, and γ-alumina having an α-transformation rate of 90% or more, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating a raw material of magnetic iron oxide and performing annealing treatment thereon, and those obtained by performing surface treatment on them with aluminum and/or silica as necessary.

### Curing Agent

Examples of the curing agent include a polyisocyanate. Examples of the polyisocyanate include an aromatic polyisocyanate such as an adduct of tolylene diisocyanate (TDI) and an active hydrogen compound, and an aliphatic polyisocyanate such as an adduct of hexamethylene diisocyanate (HMDI) and an active hydrogen compound. The weight average molecular weight of the polyisocyanates is desirably in a range of 100 to 3000.

### Rust Inhibitor

Examples of the rust inhibitor include phenols, naphthols, quinones, a heterocyclic compound containing a nitrogen atom, a heterocyclic compound containing an oxygen atom, and a heterocyclic compound containing a sulfur atom.

### Non-Magnetic Reinforcing Particle

Examples of the non-magnetic reinforcing particle include aluminum oxide (α, β, or γ alumina), chromium oxide, silicon oxide, diamond, garnet, emery, boron nitride, titanium carbide, silicon carbide, and titanium oxide (rutile or anatase titanium oxide).

### Underlayer 3

The underlayer 3 is for reducing the recesses and projections on the surface of the base material 2 and adjusting the recesses and projections on the surface of the magnetic layer 4. The underlayer 3 is a non-magnetic layer 4 containing a non-magnetic powder, a binder, and a lubricant. The underlayer 3 supplies the lubricant to the surface of the magnetic layer 4. The underlayer 3 may further contain at least one additive of an antistatic agent, a curing agent, a rust inhibitor, or the like as necessary.

An average thickness t₂ of the underlayer 3 is favorably 0.3 μm or more and 1.2 μm or less, more favorably 0.3 μm or more and 0.9 μm or less, and 0.3 μm or more and 0.6 μm or less. Note that the average thickness t₂ of the underlayer 3 is obtained in a way similar to that for the average thickness t₁ of the magnetic layer 4. However, the magnification of the TEM image is adjusted as appropriate in accordance with the thickness of the underlayer 3. When the average thickness t₂ of the underlayer 3 is 1.2 μm or less, the stretchability of the magnetic tape 1 due to external force further increases, and thus, adjustment of the width of the magnetic tape 1 by tension adjustment becomes easier.

### Non-Magnetic Powder

The non-magnetic powder includes, for example, at least one of an inorganic particle powder or an organic particle powder. Further, the non-magnetic powder may include a carbon powder such as carbon black. Note that one type of non-magnetic powder may be used alone or two or more types of non-magnetic powder may be used in combination. The inorganic particles contain, for example, a metal, a metal oxide, a metal carbonate, a metal sulfate, a metal nitride, a metal carbide, a metal sulfide, or the like. Examples of the shape of the non-magnetic powder include, but not limited to, various shapes such as a needle shape, a spherical shape, a cubic shape, and a plate shape.

### Binder and Lubricant

The binder and the lubricant are similar to those of the magnetic layer 4 described above.

### Additive

The antistatic agent, the curing agent, and the rust inhibitor are similar to those of the magnetic layer 4 described above.

### Back Layer 5

The back layer 5 contains a binder and a non-magnetic powder. The back layer 5 may further contain at least one additive of a lubricant, a curing agent, an antistatic agent, or the like as necessary. The binder and the non-magnetic powder are similar to those of the underlayer 3 described above.

The average particle size of the non-magnetic powder is favorably 10 nm or more and 150 nm or less, and more favorably 15 nm or more and 110 nm or less. The average particle size of the non-magnetic powder is obtained in a way similar to that for the average particle size of the magnetic powder described above. The non-magnetic powder may include a non-magnetic powder having two or more granularity distributions.

The upper limit value of the average thickness of the back layer 5 is favorably 0.6 μm or less. When the upper limit value of the average thickness of the back layer 5 is 0.6 μm or less, the underlayer 3 and the base material 2 can be kept thick even in the case where the average thickness of the magnetic tape 1 is 5.6 μm or less, and thus, it is possible to maintain the traveling stability of the magnetic tape 1 in the recording/reproduction apparatus. The lower limit value of the average thickness of the back layer 5 is not particularly limited, but is, for example, 0.2 μm or more.

An average thickness t_{b} of the back layer 5 is obtained as follows. First, an average thickness tr of the magnetic tape 1 is measured. The measurement method of the average thickness t_{T} is as described in the following “Average thickness of magnetic tape 1”. Subsequently, the back layer 5 of the sample is removed with a solvent such as MEK (methyl ethyl ketone) and dilute hydrochloric acid. Next, a Laser Hologage (LGH-110C) manufactured by Mitutoyo Corporation is used to measure the thickness of the sample at five or more positions, and the measured values are simply averaged (arithmetically averaged) to calculate an average value t_{B} [μm]. After that, the average thickness t_{b} [μm] of the back layer 5 is obtained in accordance with the following formula. Note that the measurement positions are randomly selected from the sample.

t_{b} [μm]=t_{T} [μm]−t_{B} [μm]

The back layer 5 has a surface provided with numerous protruding portions. The numerous protruding portions are for forming numerous hole portions in the surface of the magnetic layer 4 under a state in which the magnetic tape 1 has been wound in a roll shape. The numerous hole portions are formed by numerous non-magnetic particles protruding from the surface of the back layer 5, for example.

### Average Thickness of Magnetic Tape 1

The upper limit value of the average thickness (average total thickness) tr of the magnetic tape 1 is 5.4 μm or less, favorably 5.2 μm or less, more favorably 4.9 μm or less, and still more favorably 4.6 μm or less. When the average thickness tr of the magnetic tape 1 is 5.4 μm or less, it is possible to make the recording capacity of a single data cartridge 10 larger than that of a general magnetic tape 1. The lower limit value of the average thickness tr of the magnetic tape 1 is not particularly limited, but is, for example, 3.5 μm or more.

The average thickness tr of the magnetic tape 1 is obtained as follows. First, the magnetic tape 1 having a width of ½ inch is prepared and cut into a length of 250 mm to prepare a sample. Next, a Laser Hologage (LGH-110C) manufactured by Mitutoyo Corporation is used as a measuring apparatus to measure the thickness of the sample at five or more positions, and the measured values are simply averaged (arithmetically averaged) to calculate an average value tr [μm]. Note that the measurement positions are randomly selected from the sample.

### Coercive Force Hc

The upper limit value of a coercive force Hc2 of the magnetic layer 4 in the longitudinal direction of the magnetic tape 1 is favorably 2400 Oe or less, more favorably 2200 Oe or less, more favorably 2000 Oe or less, more favorably 1800 Oe or less, and still more favorably 1600 Oe or less. When the coercive force Hc2 of the magnetic layer 4 in the longitudinal direction is 2200 Oe or less, sufficient electromagnetic conversion characteristics can be provided even with high recording density.

The lower limit value of the coercive force Hc2 of the magnetic layer 4 measured in the longitudinal direction of the magnetic tape 1 is favorably 1000 Oe or more. When the coercive force Hc2 of the magnetic layer 4 measured in the longitudinal direction is 1000 Oe or more, it is possible to suppress demagnetization due to leakage flux from the recording head.

The coercive force Hc2 described above is obtained as follows. First, the magnetic tape 1 housed in the cartridge 10 is unwound, the magnetic tape 1 is cut at the position of 30 m from one end thereof on the outermost periphery side, and three magnetic tapes 1 are superimposed with double sided tape such that the orientations of the magnetic tapes 1 in the longitudinal direction are the same, and then punched out with a punch of @6.39 mm to prepare a measurement sample. At this time, marking is performed with arbitrary non-magnetic ink such that the longitudinal direction (traveling direction) of the magnetic tape 1 can be recognized. Then, a vibrating sample magnetometer (VSM) is used to measure the M-H loop of the measurement sample (entire magnetic tape 1) corresponding to the longitudinal direction (traveling direction) of the magnetic tape 1. Next, acetone, ethanol, or the like is used to wipe off the coating film (underlayer 3, the magnetic layer 4, the back layer 5, and the like) of the magnetic tape 1 cut as described above, leaving only the base material 2. Then, three obtained base materials 2 are superimposed with double sided tape, and then punched out with a punch of 06.39 mm to prepare a sample for background correction (hereinafter, referred to simply as “correction sample”). After that, the M-H loop of the correction sample (base material 2) corresponding to the vertical direction of the base material 2 (vertical direction of the magnetic tape 1) is measured using the VSM.

In the measurement of the M-H loop of the measurement sample (entire magnetic tape 1) and the M-H loop of the correction sample (base material 2), a highly sensitive vibrating sample magnetometer “VSM-P7-15” manufactured by TOEI INDUSTRY CO., LTD. is used. The measurement conditions are the measurement mode: full-loop, the maximum magnetic field: 15 kOe, the magnetic field step: 40 bits, the time constant of locking amp: 0.3 sec, the waiting time: 1 sec, and the MH average number: 20.

After the M-H loop of the measurement sample (entire magnetic tape 1) and the M-H loop of the correction sample (base material 2) are obtained, the M-H loop of the correction sample (base material 2) is subtracted from the M-H loop of the measurement sample (entire magnetic tape 1) to perform background correction, thereby obtaining the M-H loop after background correction. A measurement/analysis program attached to the “VSM-P7-15” is used for this calculation of background correction. The coercive force Hc2 is obtained on the basis of the obtained M-H loop after background correction. Note that the measurement/analysis program attached to the “VSM-P7-15” is used for this calculation. Note that the measurement of the M-H loop described above is performed at 25 °C±2 °C and 50% RH±5% RH. Further, the “demagnetizing field correction” in measuring the M-H loop in the longitudinal direction of the magnetic tape 1 is not performed.

### Squareness Ratio

A squareness ratio S1 of the magnetic layer 4 in the vertical direction (thickness direction) of the magnetic tape 1 is favorably 60% or more, more favorably 65% or more, still more favorably 70% or more, particularly favorably 75% or more, and most favorably 80% or more. When the squareness ratio S1 is 60% or more, the perpendicular orientation property of the magnetic powder is sufficiently high, and thus, it is possible to achieve more excellent electromagnetic conversion characteristics (e.g., SNR).

The squareness ratio S1 in the vertical direction is obtained as follows. First, the magnetic tape 1 housed in the cartridge 10 is unwound, the magnetic tape 1 is cut at the position of 30 m from one end thereof on the outermost periphery side, and three magnetic tapes 1 are superimposed with double sided tape such that the orientations of the magnetic tapes 1 in the longitudinal direction are the same, and then punched out with a punch of φ6.39 mm to prepare a measurement sample. At this time, marking is performed with arbitrary non-magnetic ink such that the longitudinal direction (traveling direction) of the magnetic tape 1 can be recognized. Then, the M-H loop of the measurement sample (entire magnetic tape 1) corresponding to the longitudinal direction (traveling direction) of the magnetic tape 1 is measured using a vibrating sample magnetometer (VSM). Next, acetone, ethanol, or the like is used to wipe off the coating film (underlayer 3, the magnetic layer 4, the back layer 5, and the like) of the magnetic tape 1 cut as described above, leaving only the base material 2. Then, three obtained base materials 2 are superimposed with double sided tape, and then punched out with a punch of φ6.39 mm to prepare a sample for background correction (hereinafter, referred to simply as “correction sample”). After that, the M-H loop of the correction sample (base material 2) corresponding to the vertical direction of the base material 2 (vertical direction of the magnetic tape 1) is measured using the VSM.

In the measurement of the M-H loop of the measurement sample (entire magnetic tape 1) and the M-H loop of the correction sample (base material 2), a highly sensitive vibrating sample magnetometer “VSM-P7-15” manufactured by TOEI INDUSTRY CO., LTD. is used. The measurement conditions are the measurement mode: full-loop, the maximum magnetic field: 15 kOe, the magnetic field step: 40 bits, the time constant of locking amp: 0.3 sec, the waiting time: 1 sec, and the MH average number: 20.

After the M-H loop of the measurement sample (entire magnetic tape 1) and the M-H loop of the correction sample (base material 2) are obtained, the M-H loop of the correction sample (base material 2) is subtracted from the M-H loop of the measurement sample (entire magnetic tape 1) to perform background correction, thereby obtaining the M-H loop after background correction. The measurement/analysis program attached to the “VSM-P7-15” is used for this calculation of background correction.

A saturation magnetization Ms (emu) and a residual magnetization Mr (emu) of the obtained M-H loop after background correction are substituted into the following formula to calculate the squareness ratio S1(%). Note that the measurement of the M-H loop described above is performed at 25 °C±2 °C and 50% RH±5% RH. Further, the “demagnetizing field correction” in measuring the M-H loop in the vertical direction of the magnetic tape 1 is not performed. Note that the measurement/analysis program attached to the “VSM-P7-15” is used for this calculation.

Squareness ratio S1(%)=(Mr/Ms)×100

A squareness ratio S2 of the magnetic layer 4 in the longitudinal direction (traveling direction) of the magnetic tape 1 is favorably 35% or less, more favorably 30% or less, still more favorably 25% or less, particularly favorably 20% or less, and most favorably 15% or less. When the squareness ratio S2 is 35% or less, the perpendicular orientation property of the magnetic powder is sufficiently high, and thus, it is possible to achieve more excellent electromagnetic conversion characteristics (e.g., SNR).

The squareness ratio only needs to satisfy a value in one of the vertical direction and the longitudinal direction. In particular, in the magnetic tape 1 in which the magnetic layer is as thin as 100 nm or less, it is better to place more emphasis on the squareness ratio in the longitudinal direction than in the vertical direction where the influence of demagnetizing field tends to be different.

The squareness ratio S2 in the longitudinal direction is obtained in a way similar to that for the squareness ratio S1 except for measuring the M-H loop in the longitudinal direction (traveling direction) of the magnetic tape 1 and the base material 2.

### Surface Roughness R_{b} of Back Surface

A surface roughness R_{b} of the back surface (surface roughness of the back layer 5) favorably satisfies the relationship of R_{b}≤6.0 [mm]. When the surface roughness R_{b} of the back surface is within the range described above, it is possible to achieve more excellent electromagnetic conversion characteristics.

### Others

The present technology may also take the following configurations.

(1) A servo measurement apparatus, including:
a servo read head that reads a servo pattern written to a servo band of a magnetic tape and reproduces a servo signal with a waveform; and
a control unit that calculates a width of the servo pattern on the basis of a first point and a second point that are respectively different from a peak point on a positive side and a peak point on a negative side in the waveform of the servo signal.

(2) The servo measurement apparatus according to (1), in which
the control unit sets a point corresponding to any one of rise portions of crests on the positive side in the waveform of the servo signal as the first point.

(3) The servo measurement apparatus according to (2), in which
the control unit sets a point corresponding to any one of rise portions of troughs on the negative side in the waveform of the servo signal as the second point.

(4) The servo measurement apparatus according to (3), in which
the control unit sets, when an output value of the peak point on the positive side in the waveform of the servo signal is set to 100%, a point corresponding to an output value, which is a first percentage with respect to the peak point on the positive side, as the first point.

(5) The servo measurement apparatus according to (4), in which
the control unit sets, when the output value of the peak point on the negative side in the waveform of the servo signal is set to −100%, a point corresponding to an output value, which is a second percentage with respect to the peak point on the negative side, as the second point.

(6) The servo measurement apparatus according to (5), in which
the control unit sets any value within a range of 25% or more and 75% or less as the first percentage.

(7) The servo measurement apparatus according to (6), in which
the control unit sets any value within a range of −25% or more and −75% or less as the second percentage.

(8) The servo measurement apparatus according to any one of (5) to (7), in which
the control unit sets the first percentage and the second percentage such that absolute values of the first percentage and the second percentage are equal.

(9) The servo measurement apparatus according to any one of (1) to (8), in which
the magnetic tape includes a magnetic layer of a perpendicularly oriented type to which the servo pattern is written.

(10) The servo measurement apparatus according to (9), in which
the magnetic layer has a squareness ratio in a perpendicular direction of 60% or more.

(11) The servo measurement apparatus according to any one of (1) to (10), in which
the control unit is capable of changing at least one of the first point or the second point.

(12) The servo measurement apparatus according to (11), in which
the control unit changes at least one of the first point or the second point on the basis of a perpendicular orientation of a magnetic layer to which the servo pattern is written.

(13) The servo measurement apparatus according to any one of (5) to (11), in which
the control unit is capable of changing at least one of the first percentage or the second percentage.

(14) The servo measurement apparatus according to (13), in which
the control unit changes at least one of the first percentage or the second percentage on the basis of a perpendicular orientation of a magnetic layer to which the servo pattern is written.

(15) The servo measurement apparatus according to any one of (1) to (14), in which
the control unit measures the width of the servo pattern for each servo truck in the servo band.

(16) The servo measurement apparatus according to any one of (1) to (15), in which
an old data recording apparatus compatible with a magnetic tape of an old LTO type is reused as the servo measurement apparatus.

(17) A servo measurement method, including:
reading a servo pattern written to a servo band of a magnetic tape and reproducing a servo signal with a waveform; and
calculating a width of the servo pattern on the basis of a first point and a second point that are respectively different from a peak point on a positive side and a peak point on a negative side in the waveform of the servo signal.

(18) A program that causes a servo measurement apparatus to execute processing including:
reading a servo pattern written to a servo band of a magnetic tape and reproducing a servo signal with a waveform; and
calculating a width of the servo pattern on the basis of a first point and a second point that are respectively different from a peak point on a positive side and a peak point on a negative side in the waveform of the servo signal.

(19) A method of producing a magnetic tape, including:
reading a servo pattern written to a servo band of a magnetic tape and reproducing a servo signal with a waveform;
calculating a width of the servo pattern on the basis of a first point and a second point that are respectively different from a peak point on a positive side and a peak point on a negative side in the waveform of the servo signal; and
checking quality of the magnetic tape on the basis of the width of the servo pattern.

(20) A magnetic tape in which
a servo pattern written to a servo band of a magnetic tape is read and a servo signal with a waveform is reproduced,
a width of the servo pattern is calculated on the basis of a first point and a second point that are respectively different from a peak point on a positive side and a peak point on a negative side in the waveform of the servo signal, and
quality of the magnetic tape is checked on the basis of the width of the servo pattern.

It should be understood by those skilled in the art that various modifications, combinations, sub-combinations and alterations may occur depending on design requirements and other factors insofar as they are within the scope of the appended claims or the equivalents thereof.

What is claimed is:

1. A servo measurement apparatus, comprising:
a servo read head that reads a servo pattern written to a servo band of a magnetic tape and reproduces a servo signal with a waveform; and
a control unit that calculates a width of the servo pattern on a basis of a first point and a second point that are respectively different from a peak point on a positive side and a peak point on a negative side in the waveform of the servo signal.

2. The servo measurement apparatus according to claim 1, wherein
the control unit sets a point corresponding to any one of rise portions of crests on the positive side in the waveform of the servo signal as the first point.

3. The servo measurement apparatus according to claim 2, wherein
the control unit sets a point corresponding to any one of rise portions of troughs on the negative side in the waveform of the servo signal as the second point.

4. The servo measurement apparatus according to claim 3, wherein
the control unit sets, when an output value of the peak point on the positive side in the waveform of the servo signal is set to 100%, a point corresponding to an output value, which is a first percentage with respect to the peak point on the positive side, as the first point.

5. The servo measurement apparatus according to claim 4, wherein
the control unit sets, when the output value of the peak point on the negative side in the waveform of the servo signal is set to −100%, a point corresponding to an output value, which is a second percentage with respect to the peak point on the negative side, as the second point.

6. The servo measurement apparatus according to claim 5, wherein
the control unit sets any value within a range of 25% or more and 75% or less as the first percentage.

7. The servo measurement apparatus according to claim 6, wherein
the control unit sets any value within a range of −25% or more and −75% or less as the second percentage.

8. The servo measurement apparatus according to claim 5, wherein
the control unit sets the first percentage and the second percentage such that absolute values of the first percentage and the second percentage are equal.

9. The servo measurement apparatus according to claim 1, wherein
the magnetic tape includes a magnetic layer of a perpendicularly oriented type to which the servo pattern is written.

10. The servo measurement apparatus according to claim 9, wherein
the magnetic layer has a squareness ratio in a perpendicular direction of 60% or more.

11. The servo measurement apparatus according to claim 1, wherein
the control unit is capable of changing at least one of the first point or the second point.

12. The servo measurement apparatus according to claim 11, wherein
the control unit changes at least one of the first point or the second point on a basis of a perpendicular orientation of a magnetic layer to which the servo pattern is written.

13. The servo measurement apparatus according to claim 5, wherein
the control unit is capable of changing at least one of the first percentage or the second percentage.

14. The servo measurement apparatus according to claim 13, wherein
the control unit changes at least one of the first percentage or the second percentage on a basis of a perpendicular orientation of a magnetic layer to which the servo pattern is written.

15. The servo measurement apparatus according to claim 1, wherein
the control unit measures the width of the servo pattern for each servo truck in the servo band.

16. The servo measurement apparatus according to claim 1, wherein
an old data recording apparatus compatible with a magnetic tape of an old LTO type is reused as the servo measurement apparatus.

17. A servo measurement method, comprising:
reading a servo pattern written to a servo band of a magnetic tape and reproducing a servo signal with a waveform; and
calculating a width of the servo pattern on a basis of a first point and a second point that are respectively different from a peak point on a positive side and a peak point on a negative side in the waveform of the servo signal.

18. A program that causes a servo measurement apparatus to execute processing comprising:
reading a servo pattern written to a servo band of a magnetic tape and reproducing a servo signal with a waveform; and
calculating a width of the servo pattern on a basis of a first point and a second point that are respectively different from a peak point on a positive side and a peak point on a negative side in the waveform of the servo signal.

19. A method of producing a magnetic tape, comprising:
reading a servo pattern written to a servo band of a magnetic tape and reproducing a servo signal with a waveform;
calculating a width of the servo pattern on a basis of a first point and a second point that are respectively different from a peak point on a positive side and a peak point on a negative side in the waveform of the servo signal; and
checking quality of the magnetic tape on a basis of the width of the servo pattern.

20. A magnetic tape, wherein
a servo pattern written to a servo band of a magnetic tape is read and a servo signal with a waveform is reproduced,
a width of the servo pattern is calculated on a basis of a first point and a second point that are respectively different from a peak point on a positive side and a peak point on a negative side in the waveform of the servo signal, and
quality of the magnetic tape is checked on a basis of the width of the servo pattern.
